(19) United States
(12) Patent Application Publication
(10) Pub. No.: US 2025/0104082 A1
(43) Pub. Date: Mar. 27, 2025

(54) SYSTEM AND MANAGEMENT SERVER

(71) Applicant: TOYOTA JIDOSHA KABUSHIKI KAISHA, Toyota-shi (JP)

(72) Inventors: Teruyoshi FUJIWARA, Toyota-shi (JP); Iwao Nitta, Nagoya-shi (JP); Ryota Suzuki, Ikeda-shi (JP)

(73) Assignee: TOYOTA JIDOSHA KABUSHIKI KAISHA, Toyota-shi (JP)

(21) Appl. No.: 18/806,034

(22) Filed: Aug. 15, 2024

(30) Foreign Application Priority Data
Sep. 22, 2023 (JP) 2023-159250

(51) Int. Cl. G06Q 20/40; G06Q 20/32; G06Q 30/0645

(52) U.S. Cl. CPC G06Q 20/405; G06Q 20/325; G06Q 30/0645

(57) ABSTRACT

A management server according to an aspect of the present disclosure accepts setting of a correspondence relation by receiving a linking demand in response to occurrence of a use relation between a first target and a second target. If a second correspondence relation between a first first target and a second second target different from a first second target is accepted while setting of a first correspondence relation between the first first target and the first second target is established, the management server (I) releases the first correspondence relation, and establishes setting of the second correspondence relation, or (II) does not permit setting the second correspondence relation, and maintains the setting of the first correspondence relation, according to a predetermined rule.

### CROSS REFERENCE TO THE RELATED APPLICATION

This application claims the benefit of Japanese Patent Application No. 2023-159250, filed on Sep. 22, 2023, which is hereby incorporated by reference herein in its entirety.

### BACKGROUND

### Technical Field

The present disclosure relates to a system, a management server, and a management method.

### Description of the Related Art

Japanese Patent Laid-Open No. 2022-140747 proposes a charge collection system for collecting a charge for a service from a user of a vehicle using a medium, such as a card. Specifically, the charge collection system proposed in Japanese Patent Laid-Open No. 2022-140747 is configured to allocate a billing for a use charge of an expressway on a rental car serving as a target to a target user, based on the ID of an ETC (Electronic Toll Collection System) card, a rental car business operator, a date and time of rental car use, and a correspondence relation of a rental car user (charge information, registration information, payment information, and use information).

### SUMMARY

An object of the present disclosure is to provide a technique for appropriately tracking a use relation between a first target and a second target.

A system according to a first aspect of the present disclosure includes: a management server; a plurality of first terminals each corresponding to a first target; and a plurality of second terminals each corresponding a second target. The plurality of first terminals and the plurality of second terminals are configured so that in response to occurrence of a use relation between the first target and the second target, at least one of the first terminal corresponding to the first target, and the second terminal corresponding to the second target transmits a linking demand to the management server. The management server is configured to execute: accepting setting of a correspondence relation between the first target and the second target, in response to receipt of the linking demand; and if, while setting of a first correspondence relation between a first first target and a first second target is established, setting of a second correspondence relation between the first first target and a second second target different from the first second target is accepted, (I) releasing the first correspondence relation, and establishing setting of the second correspondence relation, or (II) not permitting setting the second correspondence relation, and maintaining the setting of the first correspondence relation, according to a predetermined rule.

A management server according to a second aspect of the present disclosure includes a processor configured to execute: receiving a linking demand, from at least one of a first terminal as a first target and a second terminal as a second target, in response to occurrence of a use relation between the first target and the second target; accepting setting of a correspondence relation between the first target and the second target, in response to receipt of the linking demand; and if, while setting of a first correspondence relation between a first first target and a first second target is established, setting of a second correspondence relation between the first first target and a second second target different from the first second target is accepted, (I) releasing the first correspondence relation, and establishing setting of the second correspondence relation, or (II) not permitting setting the second correspondence relation, and maintaining the setting of the first correspondence relation, according to a predetermined rule.

A management method according to a third aspect of the present disclosure is an information processing method that causes a management server to execute: receiving a linking demand, from at least one of a first terminal as the first target and a second terminal as the second target, in response to occurrence of a use relation between the first target and the second target; accepting setting of a correspondence relation between the first target and the second target, in response to receipt of the linking demand; and if, while setting of a first correspondence relation between a first first target and a first second target is established, setting of a second correspondence relation between the first first target and a second second target different from the first second target is accepted, (I) releasing the first correspondence relation, and establishing setting of the second correspondence relation, or (II) not permitting setting the second correspondence relation, and maintaining the setting of the first correspondence relation, according to a predetermined rule.

According to the present disclosure, the technique for appropriately tracking the use relation between the first target and the second target can be provided.

### BRIEF DESCRIPTION OF THE DRAWINGS

FIG. 1 schematically illustrates an example of a situation to which the present disclosure is applied;

FIG. 2 schematically illustrates an embodiment of a situation to which the present disclosure is applied;

FIG. 3A schematically illustrates an example of linking information according to the present embodiment;

FIG. 3B schematically illustrates an example of user information according to the present embodiment;

FIG. 3C schematically illustrates an example of mobile body information according to the present embodiment;

FIG. 4 schematically illustrates an example of a settlement process according to the present embodiment;

FIG. 5 schematically illustrates an example of the settlement process according to the present embodiment;

FIG. 6A schematically illustrates an example of a settlement process according to whether a predetermined relation is established or not according to the present embodiment;

FIG. 6B schematically illustrates an example of the settlement process according to whether the predetermined relation is established or not according to the present embodiment;

FIG. 7 schematically illustrates an example of a situation where linking setting is locked according to the present embodiment;

FIG. 8 schematically illustrates an example of a procedure of releasing linking according to the present embodiment;

FIG. 9 schematically illustrates an example of a situation of using linking information according to the present embodiment;

FIG. 10A schematically illustrates an example of a hardware configuration of a management server according to the present embodiment;

FIG. 10B schematically illustrates an example of a hardware configuration of a first terminal according to the present embodiment;

FIG. 10C schematically illustrates an example of a hardware configuration of a second terminal according to the present embodiment;

FIG. 11 schematically illustrates an example of a software configuration of each apparatus according to the present embodiment;

FIG. 12 schematically illustrates an example of a processing procedure of linking setting according to the present embodiment;

FIG. 13 schematically illustrates an example of a processing procedure of linking release according to the present embodiment;

FIG. 14 schematically illustrates an example of a processing procedure of linking setting in a case of adopting a first authentication method;

FIG. 15 schematically illustrates an example of a processing procedure of linking setting in a case of adopting a second authentication method;

FIG. 16 schematically illustrates an example of a processing procedure of linking setting in a case of adopting a 3-1-th authentication method;

FIG. 17A schematically illustrates an example of a processing procedure of linking setting in a case of adopting a 3-2-th authentication method;

FIG. 17B schematically illustrates another example of the processing procedure of linking setting in the case of adopting the 3-2-th authentication method;

FIG. 18A schematically illustrates an example of a processing procedure of linking setting in a case of adopting a fourth authentication method; and

FIG. 18B schematically illustrates another example of the processing procedure of linking setting in the case of adopting the fourth authentication method.

### DESCRIPTION OF THE EMBODIMENTS

According to the system proposed in Japanese Patent Laid-Open No. 2022-140747, a user can make a payment for an expressway charge through the ETC even if they do not have their own ETC card. However, the inventors of this application have found out that the conventional system has the following problems.

That is, as the MaaS (Mobility as a Service) is diversified, it is conceivable that in view of convenience of improving the efficiency of payment and the like, a request for appropriately tracking use of a mobile body by the user occurs. Meanwhile, although the conventional system can hold, as use information, the correspondence relation between a use date and time and a user in response to a contract or a reservation for a rental car, the use information does not necessarily match actual use of the rental car by the user because the use date and time depends on the contract or the reservation. Furthermore, in a case of a vehicle to be used without a contract or a reservation (e.g., a private car), generation of the use information is not assumed in the first place. Consequently, according to the conventional system, it is difficult to appropriately track the use of the mobile body by the user. Note that occurrence of this problem is not limited to a situation of using a vehicle. Similar problems can occur even in a situation of using a mobile body (e.g., an air vehicle, a vessel, etc.) other than a vehicle, and a situation of using multiple types of mobile bodies. Furthermore, similar problems can occur also in every use situation other than that with a mobile body.

In contrast, a system according to a first aspect of the present disclosure includes: a management server; a plurality of first terminals each corresponding to a first target; and a plurality of second terminals each corresponding a second target. The plurality of first terminals and the plurality of second terminals are configured so that in response to occurrence of a use relation between the first target and the second target, at least one of the first terminal corresponding to the first target, and the second terminal corresponding to the second target transmits a linking demand to the management server. The management server is configured to execute: accepting setting of a correspondence relation between the first target and the second target, in response to receipt of the linking demand; and if, while setting of a first correspondence relation between a first first target and a first second target is established, setting of a second correspondence relation between the first first target and a second second target different from the first second target is accepted, (I) releasing the first correspondence relation, and establishing setting of the second correspondence relation, or (II) not permitting setting the second correspondence relation, and maintaining the setting of the first correspondence relation, according to a predetermined rule.

According to the first aspect of the present disclosure, by the setting (linking setting) of the correspondence relation between the first target and the second target, the use relation between the first target and the second target can be tracked. In addition, according to the first aspect of the present disclosure, in case setting of multiple correspondence relations occur (linking settings collide), settlement according to a predetermined rule selects setting of the correspondence relation to be held. Consequently, according to the first aspect of the present embodiment, the use relation between the first target and the second target can be appropriately tracked.

Note that the implementation of the present disclosure is not limited to the example described above. As another implementation of the system according to the aspect described above, an aspect of the present disclosure may be an information processing apparatus that achieves all, some, or part of the components described above, an information processing method, a program, or a storage medium that stores such a program and can be read by a machine, such as a computer. Here, the storage medium that can be read by the machine is a medium that accumulates information such as a program through electrical, magnetic, optical, mechanical, or chemical action. The information processing apparatus may be at least any of a management server, the first terminal, and the second terminal according to the aspects described above. The system according to the aspect described above may further include at least one of a first server engaged in authentication of the first target, and a second server engaged in the second target.

For example, a management server according to a second aspect of the present disclosure may include a controller configured to execute: receiving a linking demand, from at least one of a first terminal as a first target and a second terminal as a second target, in response to occurrence of a use relation between the first target and the second target; accepting setting of a correspondence relation between the first target and the second target, in response to receipt of the linking demand; and if, while setting of a first correspondence relation between a first first target and a first second target is established, setting of a second correspondence relation between the first first target and a second second target different from the first second target is accepted, (I) releasing the first correspondence relation, and establishing setting of the second correspondence relation, or (II) not permitting setting the second correspondence relation, and maintaining the setting of the first correspondence relation, according to a predetermined rule.

For example, a management method according to a third aspect of the present disclosure may be an information processing method that causes a management server to execute: receiving a linking demand, from at least one of a first terminal as a first target and a second terminal as a second target, in response to occurrence of a use relation between the first target and the second target; accepting setting of a correspondence relation between the first target and the second target, in response to receipt of the linking demand; and if, while setting of a first correspondence relation between a first first target and a first second target is established, setting of a second correspondence relation between the first first target and a second second target different from the first second target is accepted, (I) releasing the first correspondence relation, and establishing setting of the second correspondence relation, or (II) not permitting setting the second correspondence relation, and maintaining the setting of the first correspondence relation, according to a predetermined rule.

Hereinafter, an embodiment according to an aspect of the present disclosure (hereinafter also represented as “present embodiment”) is described with reference to the drawings. Note that the present embodiment described below is only an example in all respects. Without departing from the scope of the disclosure, various improvements and modifications may be made. To implement the present disclosure, a specific configuration supporting a corresponding embodiment can be appropriately adopted. Although data included in the present embodiment is described as that in a natural language, more specifically, the data is designated in a pseudo-language recognizable by a computer, commands, parameters, a machine language, etc.

### [1 Application Example]

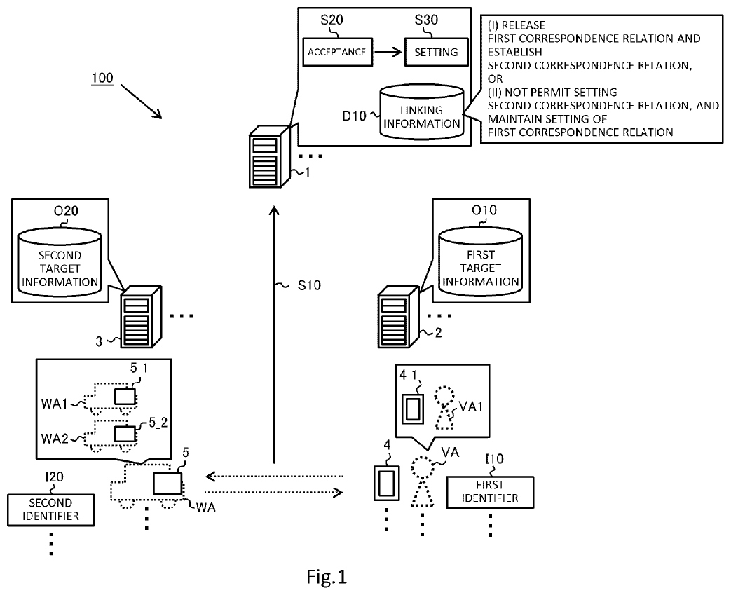

FIG. 1 schematically illustrates an example of a situation to which the present disclosure is applied. A system 100 according to the present embodiment includes a management server 1, a plurality of first terminals 4, and a plurality of second terminals 5. The management server 1 is one or more computers that are configured to record correspondence relations (linking) between first targets VA and second targets WA. The first terminals 4 correspond to the respective first targets VA. The second terminals 5 correspond to the respective second targets WA.

In the present embodiment, the plurality of first terminals 4 and the plurality of second terminals 5 are configured so that in response to occurrence of a use relation between the first target VA and the second target WA, at least one of the first terminal 4 corresponding to the first target VA, and the second terminal 5 corresponding to the second target WA transmits a linking demand to the management server 1. For example, between the first target VA and the second target WA, the use relation occurs on a one-to-one basis. That is, between one first target VA and one second target WA, the use relation occurs. One first target VA is one individual among the first targets VA. One second target WA is one individual among the second targets WA. One individual with which the use relation occurs may be called “individual concerned” or “target individual”. In response to occurrence of the use relation, at least one of one first terminal 4 corresponding to an individual concerned among the first targets VA, and one second terminal 5 corresponding to an individual concerned among the second targets WA transmits a linking demand to the management server 1 (step S10).

In response to this, the management server 1 receives the linking demand, from at least one of the first terminal 4 as the first target VA, and the second terminal 5 as the second target WA. In response to receipt of the linking demand, the management server 1 accepts setting of the correspondence relation between the first target VA and the second target WA (step S20). In response to the accepted linking demand, the management server 1 sets the correspondence relation between the individual concerned among the first targets VA, and the individual concerned among the second targets WA (step S30).

In this process, no linking setting collision occurs if the individual concerned among the first targets VA that serves as the target of the linking demand has no setting of the correspondence relation with another second target WA (another individual among the second targets WA) different from the second target WA to be paired by the linking demand. Absence of setting of a correspondence relation with the other second target WA means that the identical first target VA has no established setting of a correspondence relation with multiple second targets WA. Accordingly, in such a case, the management server 1 may set the correspondence relation between the individual concerned among the first targets VA and the individual concerned among the second targets WA as indicated.

On the other hand, if the individual concerned among the first targets VA has already had a correspondence relation with another second target WA, setting of a correspondence relation with multiple second targets WA is to occur for the identical first target VA, thus causing a linking setting collision. The fact that there has already been a correspondence relation with the other second target WA when a linking demand is accepted corresponds to acceptance of setting of a second correspondence relation between a first first target VA1 and a second second target WA2 different from a first second target WA1 during establishment of setting of a first correspondence relation between the first first target VA1 and the first second target WA1. In such a case, the management server 1 (I) releases the first correspondence relation, and establishes setting of the second correspondence relation, or (II) does not permit setting the second correspondence relation, and maintains the first correspondence relation, according to a predetermined rule. Selection of (I) corresponds to selection of a new correspondence relation (second correspondence relation) as a correspondence relation to be held. Selection of (II) corresponds to selection of an existing correspondence relation (first correspondence relation) as a correspondence relation to be held. Denial of permission for setting the second correspondence relation corresponds to dismissal of a linking demand for setting the second correspondence relation. Thus, the management server 1 settles a linking setting collision.

The first first target VA1 is one individual among the first targets VA that accepts setting of the correspondence relation. The first first target VA1 may also be called a first individual among the first targets VA. The first second target WA1 is one individual among the second targets WA that has previously established setting of a correspondence relation (first correspondence relation) with the first first target VA1. The first second target WA1 may also be called a first individual among the second targets WA. The second second target WA2 is one individual among the second targets WA that newly requests setting of a correspondence relation with the first first target VA1 during establishment of the first correspondence relation. The second second target WA2 may also be called a second individual among the second targets WA. In the following description, for convenience sake, the first terminal 4 of the first first target VA1 is also called “first first terminal 4_1”, the second terminal 5 of the first second target WA1 is also called “first second terminal 5_1”, and the second terminal 5 of the second second target WA2 is also called “second second terminal 5_2”.

Note that when a use relation occurs between the first target VA and the second target WA, data exchange may be executed between the first terminal 4 corresponding to the individual concerned among the first targets VA, and the second terminal 5 corresponding to the individual concerned among the second targets WA. At this data exchange, a linking demand may be executed. A series of processes from the linking demand to linking setting may be executed in real time upon occurrence of the use relation. After the setting, the correspondence relation (linking) may be released at any timing. For example, the correspondence relation may be released in response to extinction of the use relation.

Only if each individual with which the correspondence relation is set can be identified, the representational form of information indicating the setting of the correspondence relation is not necessarily specifically limited, and may be appropriately determined depending on an embodiment. For example, each first target VA may be assigned a first identifier I10, and each individual among the first targets VA may be identified by the first identifier I10. Likewise, each second target WA may be assigned a second identifier I20, and each individual among the second targets WA may be identified by the second identifier I20. Accordingly, setting of the correspondence relation between the individual concerned among the first targets VA and the individual concerned among the second targets WA may be achieved by setting a correspondence relation between the first identifier I10 assigned to the individual concerned among the first targets VA, and the second identifier I20 assigned to the individual concerned among the second targets WA. That is, setting of the correspondence relation may be represented using the first identifier I10 and the second identifier I20.

As described above, in the present embodiment, by setting the correspondence relation between the first target VA and the second target WA, the use relation between the individual concerned among the first targets VA and the individual concerned among the second targets WA can be tracked. In addition, in the present embodiment, in case linking setting with multiple individuals among the second targets WA occurs for one individual among the first targets VA, the management server 1 executes a settlement process of selecting a correspondence relation to be held, according to a predetermined rule, thus resolving a linking setting collision. Consequently, according to the present embodiment, the correspondence relation between the first target VA and the second target WA can be appropriately tracked.

### (Target)

Only if a use relation can be established, the first target VA and the second target WA are not necessarily specifically limited, and may be appropriately selected depending on an embodiment. Each of the first target VA and the second target WA may be an arbitrary object, such as a physical body, a person, or another living object. Such an arbitrary object may be a virtual object. Establishment of the use relation may be, for example, occurrence of an actual or virtual relation between at least two objects, such as one party using the other party, one party carrying the other party, one party being combined with the other party, or one party being connected to the other party. The system 100 in the present disclosure may be used in any situation of tracking a correspondence relation between two or more objects.

Note that in the present embodiment, when a linking setting with each of individuals of the second targets WA is to be established to the individual concerned among the first targets VA, the management server 1 executes a settlement process of selecting one linking setting as a linking setting to be held, from among a plurality of linking settings. By the settlement process, the linking setting collision is resolved. On the other hand, handling of linking setting to the individual concerned among the second targets WA with each of individuals among the first targets VA may be similar to or different from that for the first target VA. That is, when a linking setting with each of individuals of the first targets VA is to be established to the individual concerned among the second targets WA, similarly to the case of the first target VA, the management server 1 may execute the settlement process of selecting one linking setting as a linking setting to be held, from among a plurality of linking settings. Alternatively, the management server 1 may execute no settlement process, but permit a plurality of linking settings to the same second target WA (the identical individual of the second target WA). For example, a situation where the first target VA is a user, and the second target WA is a mobile body is assumed. In a case where a plurality of users can use the mobile body (for example, a case where the mobile body is a vehicle allowing a plurality of passengers to be on board), linking settings of the respective users to the identical mobile body can be appropriately achieved. In such a case, establishment of multiple linking settings to the identical individual among the second targets WA may be permitted. One target that does not permit multiple linking settings may be selected as the first target VA between two objects whose use relation is to be tracked. The other object that permits establishing multiple linking settings may be selected as the second target WA.

### (Terminal)

The terminals (4 and 5) relate to the targets (VA and WA). The relations between the terminals (4 and 5) and the targets (VA and WA) are not necessarily specifically limited, and may be appropriately determined depending on the embodiment. For example, each first terminal 4 may accompany the corresponding first target VA, and each second terminal 5 may accompany the corresponding second target WA. Accompanying may include temporary or permanent installation inside or outside of a target, being carried by a target (person), and being carried by a person related to a target (physical body). Installation may include loading. Loading may include not only regular placement on the target, but also at least temporary placement on the target in the case of using the target. Loading may include carrying by a user of the target. Any one of the first terminal 4 and the second terminal 5 may be the target itself. Note that as for the terminals (4 and 5), for example, as in a case or the like where one user shares an account among multiple terminals (4 and 5), the multiple terminals may be used as the terminals of the identical individual. In this case, the multiple terminals used by the identical individual can be construed as one terminal of the identical individual.

### (Target Information)

For example, to describe each individual among the first targets VA in detail, first target information O10 about the first target VA may be used. The first target information O10 may include the first identifier I10. Likewise, to describe each individual among the second targets WA in detail, second target information O20 about the second target WA may be used. The second target information O20 may include the second identifier I20. The first target information O10 and the second target information O20 may held in any storage region. At least part of each of the first target information O10 and the second target information O20 may be held so as be accessible from at least any of the management server 1, the external server, and the terminals (4 and 5).

The first target information O10 and the second target information O20 may be appropriately managed. In the example in FIG. 1, a first server 2 may be configured to manage the first target information O10, and a second server 3 may be configured to manage the second target information O20. The first server 2 and the second server 3 may each be made up of one or more server apparatuses. The first target information O10 may be stored in a memory resource installed in at least one of the inside and outside of the first server 2, in a manner accessible from the first server 2. The second target information O20 may be stored in a memory resource installed in at least one of the inside and outside of the second server 3, in a manner accessible from the second server. The internal memory resource may include, for example, a RAM (Random Access Memory), an auxiliary storage device, a storage medium, and the like. The external memory resource may include, for example, an external storage device, an external computer (NAS: Network Attached Storage etc.), and the like. In another example, pieces of the target information (O10 and O20) may be stored in the memory resource of the management server 1.

Units of managing pieces of the target information (O10 and O20) are not necessarily specifically limited, and may be appropriately determined depending on an embodiment. At least one of the first target information O10 and the second target information O20 may be managed in a centralized manner (collectively), or managed in a distributed manner (separately) on any group basis. The server apparatus constituting each server (2, 3) may be installed by one or more operating institutions (subject individuals). At least one of the first server 2 and the second server 3 may be installed by a plurality of operating institutions. In the case of installation by multiple operating institutions, the target information may be shared (i.e., managed in a centralized manner), or may be managed in a distributed manner with respect to each operating institution.

For example, at least one of transmission of a linking demand, and acceptance of setting of a correspondence relation may include authentication of at least one of the individual concerned among the first targets VA, and the individual concerned among the second targets WA. Authentication of the individual concerned may be performed by any method. The authentication processing may be executed by at least any of the terminals (4 and 5), the external servers (e.g., the first server 2, and the second server 3), and the management server 1. For example, the pieces of the target information (O10 and O20) may include information used to authenticate the respective targets (VA and WA) (e.g., the registered specific information etc.). In another example, the servers (2 and 3) may issue information (time-limited certificates) used to authenticate the respective targets (VA and WA). In a case where at least part of the authentication processing is executed by the external server or the management server 1, the linking demand may include data used for authentication. The management server 1 may be configured to execute a process of linking setting (step S30) only if the authentication is achieved.

### (Identifier)

For example, to identify the individuals of the targets (VA and WA), the respective identifiers (I10 and I20) may be used. Only if the identifiers (I10 and I20) can identify the individuals of the respective targets (VA and WA), their data formats and configurations are not necessarily specifically limited, and may be appropriately selected depending on an embodiment. For example, each of the identifiers (I10 and I20) may be made up of a symbol string that includes numerals, characters, and the like. In another example, specific information, such as identification information uniquely assigned to each target (VA, WA), or information derived from each terminal (4, 5) may be used as the corresponding identifier (I10, I20) The uniquely assigned identification information may be, for example, a vehicle registration number, a vehicle identification number (VIN), a personal number, or the like. In a case where the target is assigned an IC tag, the uniquely assigned identification information may include information held in the IC tag. The information derived from each terminal (4, 5) may be, for example, a MAC address (Media Access Control address), a terminal identification information (IMEI: International Mobile Equipment Identifier, IMSI: International Mobile Subscriber Identity, MEID: Mobile Equipment Identifier, ICCID: Integrated Circuit Card ID, another serial number, etc.) or the like.

### (Management Server)

The management server 1 is configured to set the correspondence relation between the first target VA and the second target WA in response to a linking demand issued from at least one of the first terminal 4 and the second terminal 5. The management server 1 may directly receive a linking demand, from at least one of the first terminal 4 and the second terminal 5, or indirectly receive it through the external computer (e.g., the first server 2, the second server 3, etc.). That is, transmission of the linking demand to the management server 1 may include direct transmission of the linking demand to the management server 1, and indirect transmission via the external computer. For example, indirect transmission may include causing the external computer to simply relay the linking demand. In another example, indirect transmission may include transmitting a request for a process related to linking, to the external computer, and causing the external computer to transmit information of some kind in response to a result of execution thereof, such as requesting each server (2, 3) to authenticate the corresponding target (VA, WA) and transmit an authentication result to the management server 1, for example. That is, the linking demand may be transmitted from the external computer to the management server 1, as a result of data communication for another purpose with the external computer.

The management server 1 may receive a linking demand (a request for linking setting) in response to occurrence of the use relation, and set a correspondence relation between the individuals concerned among the first targets VA and the second targets WA in response to the received linking demand. The management server 1 may receive a release demand (a request for releasing the linking) in response to extinction of the use relation, and appropriately release the correspondence relation in response to the received release demand. The linking demand and the release demand may be configured to designate the individual concerned to be processed, by any method. In a typical example, the linking demand and the release demand may be configured to designate the individual concerned to be processed by including the first identifier I10 and the second identifier I20. Note that the method of identifying the individual concerned to be processed is not necessarily limited to such an example, and may be appropriately changed depending on the embodiment. In another example, by using alternative information in at least one of the linking demand and the release demand, at least one of the first identifier I10 and the second identifier I20 may be omitted. For example, a combination (linking setting) of the individuals concerned among the first targets VA and the second targets WA may be assigned an identifier as alternative information. Assignment of the identifier may be made at any timing, such as a time of initial linking setting. At least one of the linking demand and the release demand may be configured so that by including the identifier, the individuals concerned among the targets (VA and WA) to be processed are designated without including at least one of the first identifier I10 and the second identifier I20.

For example, before execution of the process of (I) described above, the management server 1 may directly or indirectly transmit a query for requesting a permission for executing the process of (I) described above, to at least one of the first first terminal 4_1 and the second second terminal 5_2. In at least one of the first first terminal 4_1 and the second second terminal 5_2, a response to the query may be appropriately generated. The management server 1 may execute the process of (I) by obtaining the response of permission from at least one of the first first terminal 4_1 and the second second terminal 5_2.

The management server 1 may be made up of one or more server apparatuses. In the present embodiment, the management server 1 may be configured to record, as linking information D10, information about occurrence and extinction of the correspondence relation between the first target VA and the second target WA. The linking information D10 may be stored in the memory resource installed in at least one of the inside and outside of the management server 1. The internal memory resource may include, for example, a RAM, an auxiliary storage device, a storage medium, and the like. The external memory resource may include, for example, an external storage device, an external computer (NAS etc.), and the like.

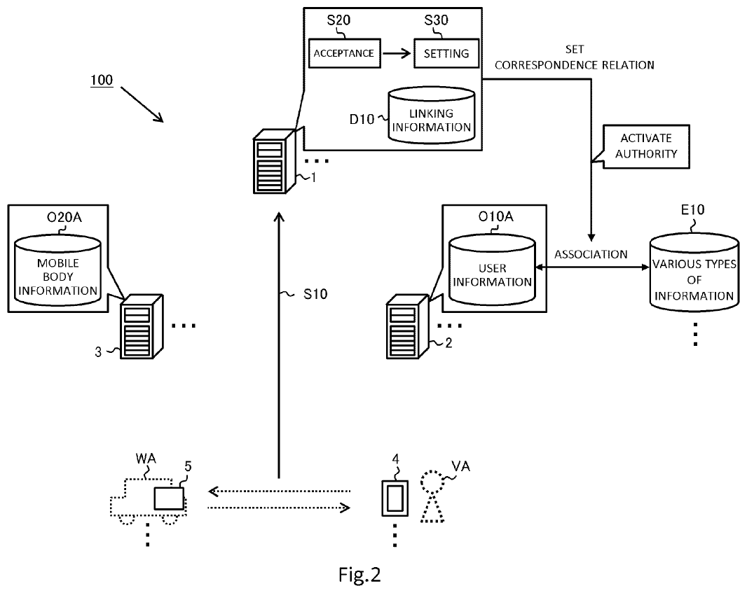

The obtained linking information D10 may be used in various situations. For example, the linking information D10 may be used to track the relation between the first target VA and the second target WA. In a specific example, the linking information D10 may be used to allow exercising the authority linked to at least one of the first target VA and the second target WA (the first target information O10 and the second target information O20) while the correspondence relation between the first target VA and the second target WA is set, from the other. That is, the linking information D10 may be used to activate exercising the authority of one of the first target VA and the second target WA from the other, in accordance with the link between the first target VA and the second target WA (FIG. 2 described later).

In an example of the present embodiment, the linking information D10 may include information on the first identifier I10 and the second identifier I20 of the individuals concerned in order to indicate the combination of the first target VA and the second target WA between which the correspondence relation is set. The management server 1 may obtain the identifiers (I10 and I20) of the respective targets as required. For example, the management server 1 may be preliminarily hold no information on the first identifier I10 and the second identifier I20 between which the correspondence relation is to be set, and obtain it from at least any of the servers (2 and 3) and the terminals (4 and 5) as required. In another example, the management server 1 may preliminarily hold information on at least one of the first identifier I10 and the second identifier I20 between which the correspondence relation is to be set.

Note that operating institutions of the management server 1 and the servers (2 and 3) may have any relation therebetween. For example, the operating institution of the management server 1 may be the same as at least one of the operating institutions of the first server 2 and the second server 3. In another example, the operating institution of the management server 1 may be different from the operating institutions of the first server 2 and the second server 3. The system 100 of the present disclosure may be produced by the management server 1 being connected to the terminals (4 and 5) via a network, and each entity being installed in a state capable of executing the information processing described above according to the intention of the operating institution of the management server 1. In a case where the servers (2 and 3) are engaged in the information processing related to linking (e.g., the authentication processing), it can be construed that the servers (2 and 3) are included in the system 100. In this case, the system 100 in the present disclosure may be produced by the management server 1 being connected further to the servers (2 and 3) via the network, and the servers (2 and 3) being further installed in a state capable of executing the information processing related to linking.

### 9 (Operation Case Example)

For example, one of the first target VA and the second target WA may be a user. One terminal corresponding to the user between the first terminal 4 and the second terminal 5 may be a user terminal related to the user. The other of the first target VA and the second target WA may be an object to be used by the user. One terminal corresponding to the object to be used between the first terminal 4 and the second terminal 5 may be a loading terminal that is mounted on the object to be used. According to an example of the present embodiment, the use relation between the user and the object to be used can be tracked.

The type of the object to be used is not necessarily specifically limited only if it can be used by the user, and may be appropriately selected depending on an embodiment. For example, the object to be used may be a mobile body (mobility). According to an example of the present embodiment, the use relation between the user and the mobile body can be tracked. Note that the type of the mobile body may be appropriately selected. The mobile body may be, for example, a vehicle, a railroad vehicle, an air vehicle (an aircraft, a drone, etc.), a vessel, or the like. The mobile body may be at least any of a manually controlled manned aircraft, and an automatically controlled unmanned aircraft. In a case where the mobile body is a vehicle, the type of the vehicle may be freely selected. The type of the vehicle may be selected from among, for example, a two-wheel vehicle, a three-wheel vehicle, four-wheel vehicle, etc. The vehicle may encompass a private car, a rental car, a shared car, a taxi, a bus, etc. The vehicle may be at least any of an autonomous driving vehicle, and a manual driving vehicle. The loading terminal may be called a mobile body terminal.

FIG. 2 schematically illustrates an embodiment of a situation to which the system 100 in the present disclosure is applied. In the example in FIG. 2, the first target VA is a user, and the second target WA is a mobile body. In the following description about the case example in FIG. 2, for convenience sake, it is dealt with so that “first” pertains to the user, and “second” pertains to the mobile body. However, the correspondence relation between “first” and “second” is not necessarily limited to the example in FIG. 2. “First” and “second” may be replaced with each other. That is, the second target WA may be the user, and the first target VA may be the mobile body.

In the case where the first target VA is the user, an example of the first terminal 4 is a user terminal. The user terminal may be, for example, a mobile body terminal (smartphone etc.), a dedicated device (electronic key device etc.), or any computer, such as another computer apparatus. Typically, the user terminal may be carried by a user as a linking target (each individual of the first target VA). An account of the user may be shared among a plurality of computers. In accordance therewith, each computer that shares the account may be used as the user terminal (first terminal 4) of the identical user.

An example of the first identifier I10 is a user identifier (a user ID or a my ID). The user identifier may be, for example, an ID of a user account, a personal number, identification information on the user terminal (e.g., an MAC address, or terminal identification information), etc. An example of the first target information O10 is user information O10A. The user information O10A may include any information about the user. For example, the user information O10A may include information about the authority of the corresponding user (a corresponding individual among users), and be thus associated with various types of information E10 for exercising the authority. The various types of information E10 may include, for example, information on public personal authentication, payment information, information on another service, etc. The information on public personal authentication may include, for example, a personal number etc. The payment information may include, for example, information on a credit card, information on Internet banking, information on electronic payment, etc. The information on another service may include, for example, information about an electronic prescription (an insurer number, prescription information, etc.). The various types of information E10 may be managed by an external system, or managed in the system 100. Note that the first server 2 may be installed by a public agency, a neutral organization, each business operator (a vehicle manufacturer, a service operating company, etc.), or the like. The first server 2 may also be called a user ID server, a my ID server, etc.

On the other hand, in the case where the second target WA is the mobile body, an example of the second terminal 5 is the mobile body terminal (loading terminal) The mobile body terminal may be, for example, a terminal attached to the inside or outside of the mobile body, a terminal carried by a person related to travel of the mobile body (e.g., a driver, a conductor, etc.), equipment installed in a facility of the mobile body (e.g., a ticket gate etc.), or the like. In the case where the mobile body is a vehicle, the mobile body terminal may be called a vehicle-mounted terminal.

An example of the second identifier I20 is a mobile body identifier (a mobile body ID, or a car ID). The mobile body identifier may be, for example, the ID of the account of the mobile body, identification information uniquely assigned to the mobile body as a target (e.g., a vehicle registration number, a vehicle identification information, etc.), identification information on the mobile body terminal, or the like. An example of the second target information O20 is mobile body information O20A. The mobile body information O20A may include any information about the mobile body. In an example in FIG. 2, in response to linking setting between the user and the mobile body, exercising at least part of the authority of each of the various types of information E10 associated with the user information O10A by the mobile body may be activated. Note that the second server 3 may be installed by a public agency, a neutral organization, each business operator (a vehicle manufacturer, a service operating company, etc.) or the like. The second server 3 may be called a mobile body ID server, a car ID server, etc.

The mobile body is an example of the object to be used. The form in FIG. 2 may be applied to any case where the user (an occupant) of the object to be used is dynamically changed. The object to be used may be not only the mobile body, but also, for example, a rental object, an accommodation facility, etc. The rental object may include a rental office, a rental space, etc.

The system 100 may be configured to set the correspondence relation (linking) between the user concerned (first identifier I10) and the individual concerned of the object to be used (second identifier I20) upon start of using the object to be used. The system 100 may be configured to release the correspondence relation (linking) between the individuals concerned upon completion of use. The start and completion of use may be detected by any method at timing such as of vehicle boarding and alighting, borrowing and returning the object to be used, etc., for example. For example, at least one of start and completion of use may be detected in response to execution of data exchange between the first terminal 4 and the second terminal 5.

Note that the objects to be used can be classified into at least two types that are objects that can be repetitively used in a long term, and objects that can be temporarily used. For the sake of description convenience, the former is called “object to be regularly used”, and the latter is called “object to be temporarily used”. An example of the object to be regularly used is an object, such as a private car, owned by the user. An example of the object to be temporarily used is a rental car, a shared car, a mobile body of a public transport system, a rental object, an object, such as an accommodation facility, owned by a person other than the user, etc. The mobile body of the public transport system is, for example, a taxi, a bus, a railroad vehicle, an aircraft, a vessel, etc.

In the system 100, the types of the objects to be used (objects to be regularly used or objects to be temporarily used) may be distinguished or not be distinguished. In the case of distinguishing the types of the object to be used, the system 100 may determine each type of the object to be used according to any method. For example, the target information (mobile body information etc.) may include information indicating the type of the object to be used. Based on this information, the system 100 may determine the type of the object to be used. In another example, the type of the object to be used may be determined based on information on an identifier or the like. In another example, information indicating the type of the object to be used may be included in information transmitted from at least one of the first terminal 4 and the second terminal 5 to the management server 1. Based on this information, the system 100 may determine the type of the object to be used. In another example, in a case where the operating institution of the server (in the example in FIG. 2, the second server 3) dealing with information on the object to be used is determined depending on the type of the object to be used, the type of the object to be used may be determined depending on what the operating institution of the server belongs to.

The system 100 may switch, for example, the forms of a process of linking setting, a link releasing condition, a method of managing the linking information D10, and an authentication processing, and the like, depending on the determined type of the object to be used.

Note that a situation to which the system 100 in the present disclosure is applied is not limited to a situation of tracking the relation between the user and the object to be used. In another example, both the first target VA and the second target WA may be robot apparatuses configured to operate autonomously by automatic control. The robot apparatuses may include mobile bodies, such as an autonomous driving vehicle, and a drone. In a situation where two or more robot apparatuses autonomously interact with each other, the system 100 in the present disclosure may be used to track occurrence and extinction of the relation between the robot apparatuses.

In a specific example, one of the first target VA and the second target WA may be a large autonomous driving vehicle, and the other may be a small autonomous driving vehicle. The large autonomous driving vehicle may be configured to be capable of storing a plurality of small autonomous driving vehicles. The small autonomous driving vehicle may be incapable of being on board of a plurality of large autonomous driving vehicles at the same time (i.e., at one time, the small autonomous driving vehicle is stored only in one large autonomous driving vehicle). Accordingly, the first target VA may be a small autonomous driving vehicle, and the second target WA may be a large autonomous driving vehicle. The large autonomous driving vehicle may appropriately collect, transport, and release each small autonomous driving vehicle. Each small autonomous driving vehicle may be appropriately operated at a release destination. In this case, the system 100 in the present disclosure may be configured to track the operation situation (e.g., in transport or not) by setting the correspondence relation between the large autonomous driving vehicle and the small autonomous driving vehicle, and switching and releasing the state.

### (Data Exchange)

In the present embodiment, a series of processes related to linking setting may be started by data exchange between the first terminal 4 and the second terminal 5 as a trigger. That is, occurrence of the use relation (start of use) may be detected by data exchange. The method of data exchange is not necessarily specifically limited, and may be appropriately selected depending on an embodiment.

For example, data exchange between the first terminal 4 and the second terminal 5 may be performed through wireless or wired data communication. The wireless communication may be performed by, for example, the NFC (Near Field Communication), Bluetooth®, Wi-fi®, or the like. The wired communication may be performed by, for example, a wired LAN (Local Area Network), the USB (Universal Serial Bus), or the like. The data communication may be performed directly between the first terminal 4 and the second terminal 5, or performed indirectly via another computer. In another example, the data exchange may be performed by a method other than data communication, such as of reading a two-dimensional code. For example, one of the first terminal 4 and the second terminal 5 may display data on a display, and the other may read the displayed data using a sensor, such as an image sensor, thus performing data exchange.

The linking demand may include at least one of the first identifier I10 and the second identifier I20. In a case where the linking demand includes the first identifier I10, the first identifier I10 may be transmitted from at least one of the first terminal 4 and the second terminal 5. In a case where the first identifier I10 is transmitted from the first terminal 4, the first terminal 4 may obtain the first identifier I10 at any timing. For example, the first identifier I10 may be preliminarily stored in the memory resource of the first terminal 4. The first terminal 4 may obtain the first identifier I10 from the memory resource. In another example, the first terminal 4 may obtain the first identifier I10 using an input device, a sensor, or the like. In a case where the first identifier I10 is transmitted from the second terminal 5, the second terminal 5 may be given the first identifier I10 from the first terminal 4 or obtain it by an autonomous operation when data is exchanged. For example, the second terminal 5 may obtain the first identifier I10 from the first terminal 4 by data communication. In another example, the second terminal 5 may obtain the first identifier I10 from the first terminal 4 by a method which is other than data communication and according to which the first terminal 4 reads the first identifier I10 displayed in a two-dimensional code etc. In still another example, the second terminal 5 may obtain the first identifier I10 from any of the first target VA and the first terminal 4 using a device, such as the input device or the sensor. Obtainment from the first target VA may include obtainment by a person related to the second target WA operating the device on behalf thereof in a case where the person related to the second target WA is present (for example, the second target WA is the person, the second target WA is operated by the person, and so on), and the first target VA is a physical body.

Likewise, in a case where the linking demand includes the second identifier I20, the second identifier I20 may be transmitted from at least one of the first terminal 4 and the second terminal 5. In a case where the second identifier I20 is transmitted from the second terminal 5, the second terminal 5 may obtain the second identifier I20 at any timing. For example, the second identifier I20 may be preliminarily stored in the memory resource of the second terminal 5. The second terminal 5 may obtain the second identifier I20 from the memory resource. In another example, the second terminal 5 may obtain the second identifier I20 using the input device, a sensor, or the like. In a case where the second identifier I20 is transmitted from the first terminal 4, the first terminal 4 may be given the second identifier I20 from the second terminal 5 or obtain it by an autonomous operation when data is exchanged. For example, the first terminal 4 may obtain the second identifier I20 from the second terminal 5 by data communication. In another example, the first terminal 4 may obtain the second identifier I20 from the second terminal 5 by a method which is other than data communication and according to which the second terminal 5 reads the second identifier I20 displayed in a two-dimensional code etc. In still another example, the first terminal 4 may obtain the second identifier I20 from any of the second target WA and the second terminal 5 using a device, such as the input device or the sensor. Obtainment from the second target WA may include obtainment by a person related to the first target VA operating the device on behalf thereof in a case where the person related to the first target VA is present (for example, the first target VA is the person, the first target VA is operated by the person, and so on), and the second target WA is a physical body.

For example, in the example in FIG. 2 described above, the first terminal 4 may obtain the second identifier I20 (mobile body identifier) from the second terminal 5 by data communication or reading a code. In a case where the second identifier I20 is a vehicle registration number, the first terminal 4 may obtain the second identifier I20 by taking an image of a license plate through an image sensor, and analyzing the obtained image. The first terminal 4 may obtain the second identifier I20 through the input device. The second terminal 5 may obtain the second identifier I20 as required. The second terminal 5 may obtain the first identifier I10 (user identifier) by data communication or reading a code. In a case where the first identifier I10 is a personal number or the like indicated on a card, the second terminal 5 may obtain the first identifier I10 by taking an image of the card through an image sensor, and analyzing the obtained image. The second terminal 5 may obtain the first identifier I10 through the input device. The first terminal 4 may obtain the first identifier I10 as required.

In the case of using the input device for obtaining data, such as each identifier (I10, I20), obtainment of the data by one terminal from another target may include not only obtainment of the data of the other target by the other target operating the input device, but also obtainment of the data of the other target by one target operating the input device. For example, in a case where the second identifier I20 is a vehicle registration number, and the input device is used to obtain the vehicle registration number in the example in FIG. 2 described above, the first terminal 4 may obtain the second identifier I20 from the mobile body (second target WA) by the user (first target VA) receiving the vehicle registration number through the input device.

Note that obtainment of the data of the other target by the one terminal is not necessarily executed when the data is exchanged. The one terminal may obtain the data of the other terminal at any timing different from that for data exchange. Any of the methods described above may be adopted as the data obtaining method. In this case, data exchange between the first terminal 4 and the second terminal 5 may function as a simple trigger for starting the series of processes related to linking setting.

### (Linking Information)

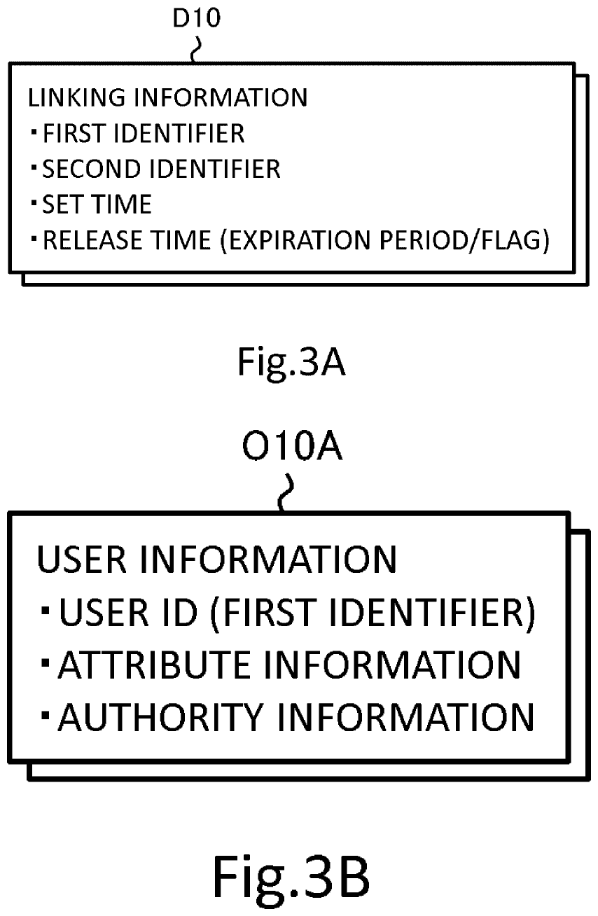

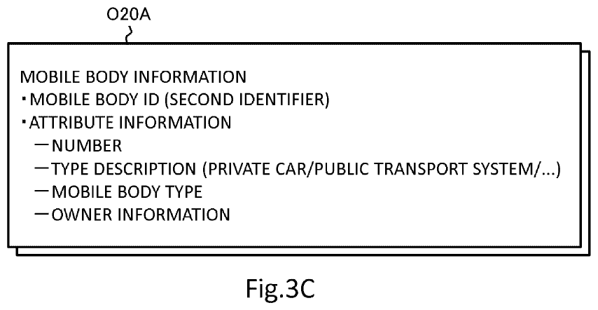

FIG. 3A schematically illustrates an example of the linking information D10 according to the present embodiment. The example in FIG. 3A assumes that a form of representing setting of the correspondence relation using the first identifier I10 and the second identifier I20 is adopted. The linking information D10 includes the first identifier I10, the second identifier I20, the set time, and the release time. The first identifier I10 and the second identifier I20 indicate the individual concerned among the first targets VA and the individual concerned among the second targets WA between which the correspondence relation (linking) is set. The set time indicates a time when the correspondence relation is set. The set time may be made up of a timestamp. The release time indicates a time when the correspondence relation is released. The value of the release time may be added when the process of releasing the correspondence relation is executed. The method of representing the release is not limited to such an example. In another example, the release time may be replaced with any one of an expiration period and a flag. The expiration period indicates a period during which setting of the correspondence relation is enabled. In this case, depending on whether it is within the expiration period or not, it is indicated whether the setting of the correspondence relation is enabled or not (i.e., the correspondence relation is set or released). The flag indicates whether the correspondence relation is released or not. The flag may be turned on when the process of releasing the correspondence relation is executed. In still another example, the linking information D10 may include at least one of the expiration period and the flag, in conjunction with a field of the release time. Note that only if the setting of the correspondence relation can be indicated, the configuration of the linking information D10 is not necessarily limited to the example in FIG. 3A, and may be appropriately changed depending on the embodiment. In another example, the linking information D10 may further include information indicating the type of the object to be used (whether it is an object to be regularly used or an object to be temporarily used). Note that the type of the object to be used is not necessarily identified by another piece of information. For example, the type of the object to be used may be identified by information, such as an identifier.

The data format of the linking information D10 is not necessarily specifically limited, and may be appropriately selected depending on an embodiment. The linking information D10 may be held in any database base. For example, the linking information D10 may be held by a relational database, such as of a table format. In another example, the linking information D10 may be held by a blockchain base. In this case, each of transactions, such as for linking setting and release may be accumulated as the linking information D10 in a blockchain. For example, the transaction for linking setting may include the first identifier I10, the second identifier I20, and the set time. The transaction for linking release may include the first identifier I10, the second identifier I20, and the release time (or information indicating release).

### (First Target Information)

The first target information O10 may include any information about the first target VA. The first target information O10 may include, for example, the first identifier I10, the attribute information on the first target VA, and information about the authority, etc. In the example in FIG. 2, the user information O10A is an example of the first target information O10.

FIG. 3B schematically illustrates an example of the user information O10A according to the present embodiment. In an example in FIG. 3B, the user information O10A includes the user ID (first identifier I10), the attribute information, and the authority information. The attribute information may include any information about the attribute of the corresponding user. The attribute information may include, for example, personal information, such as a name, an address, an age, a gender, and contact means. The authority information relates to the authority of the corresponding user. The authority information may include, for example, information for cooperating with a server that executes information processing related to the authority of the target, and information indicating the association with various types of information E10. Note that the configuration of the user information O10A is not necessarily limited to the example in FIG. 3B, and may be appropriately changed depending on an embodiment. For example, the user information O10A (first target information O10) may further include information used to authenticate the user (first target VA) (e.g., the registered specific information etc.).

The data format of the first target information O10 (user information O10A) is not necessarily specifically limited, and may be appropriately selected depending on an embodiment. The first target information O10 (user information O10A) may be held by any database base. For example, the first target information O10 (user information O10A) may be held by a relational database, such as of a table format. In another example, the first target information O10 (user information O10A) may be held by a blockchain base.

### (Second Target Information)

The second target information O20 may include any information about the second target WA. The second target information O20 may include, for example, the second identifier I20, the attribute information on the second target WA, and information about the authority, etc. In the example in FIG. 2, the mobile body information O20A is an example of the second target information O20.

FIG. 3C schematically illustrates an example of the mobile body information O20A according to the present embodiment. In the example in FIG. 3C, the mobile body information O20A includes a mobile body ID (second identifier I20), and attribute information. The attribute information includes a number, a type description (type of the target), a mobile body type, and owner information. In a case where the mobile body is a vehicle, the number may be a vehicle registration number. The type may be freely defined. According to an example, the type description may be defined to indicate a category that can distinguish, from each other, an object to be regularly used and an object to be temporarily used, such as, a private car, a rental car, a shared car, and a mobile body of a public transport system, for example. The mobile body type indicates, for example, a type, such as a vehicle type. If the mobile body type and the type description (type of the target) are identical to each other, the field of the mobile body type may be omitted. The owner information may include any information about the owner of the mobile body. The owner information may include, for example, personal information on the owner, such as a name, an address, an age, a gender, and contact means. The owner may be an incorporated entity. Note that the configuration of the mobile body information O20A is not necessarily limited to the example in FIG. 3C, and may be appropriately changed depending on an embodiment. For example, the mobile body information O20A (second target information O20) may further include information used to authenticate the mobile body (second target WA) (e.g., the registered specific information etc.). The configuration of the attribute information may be appropriately changed. For example, the mobile body information O20A (attribute information) may further include information about the mobile body terminal, such as contact means or the like of the mobile body terminal.

The data format of the second target information O20 (mobile body information O20A) is not necessarily specifically limited, and may be appropriately selected depending on an embodiment. The second target information O20 (mobile body information O20A) may be held by any database base. For example, the second target information O20 (mobile body information O20A) may be held by a relational database, such as of a table format. In another example, the second target information O20 (mobile body information O20A) may be held by a blockchain base.

### (Notification Process)

When at least one of processes of linking setting and release is executed, the management server 1 may transmit a notification indicating the execution result to at least one of the first terminal 4 and the second terminal 5. The transmission path of the notification is not necessarily specifically limited, and may be appropriately determined depending on an embodiment. For example, the management server 1 may directly notify the transmission path to at least one of the first terminal 4 and the second terminal 5. In another example, the management server 1 may indirectly notify the transmission path to at least one of the first terminal 4 and the second terminal 5 via an external computer, such as the server (2, 3).

Note that in the case of direct notification, the management server 1 may obtain the contact means of each terminal (4, 5) as required. The contact means may be a phone number, an email address, account information on a contact application (e.g., an application, such as of a social networking service), identification number, or the like. The management server 1 may obtain information indicating the contact means of each terminal (4, 5) at any timing. For example, the management server 1 may obtain the information indicating the contact means at timing of accepting a request, such as a linking demand or a release demand. The information indicating the contact means may be transmitted from at least one of the terminals (4 and 5) and the servers (2 and 3).

### (Predetermined Rule)

The predetermined rule is configured to define which one of the first correspondence relation and the second correspondence relation should be selected in a situation of settling a linking setting collision, i.e., a situation where setting of the first correspondence relation and the second correspondence relation is established. If a linking setting collision can be settled, the predetermined rule is not necessarily specifically limited, and may be appropriately defined depending on an embodiment. In a simple example, the predetermined rule may include prioritizing the latest linking demand. In a case where the predetermined rule of this mode is used, the management server 1 may (I) select release of the first correspondence relation, and establishment of the setting of the second correspondence relation, in response to the linking demand with the second second target WA2. Furthermore or alternatively, the predetermined rule may include at least any of the following three rules.

### (1) First Rule

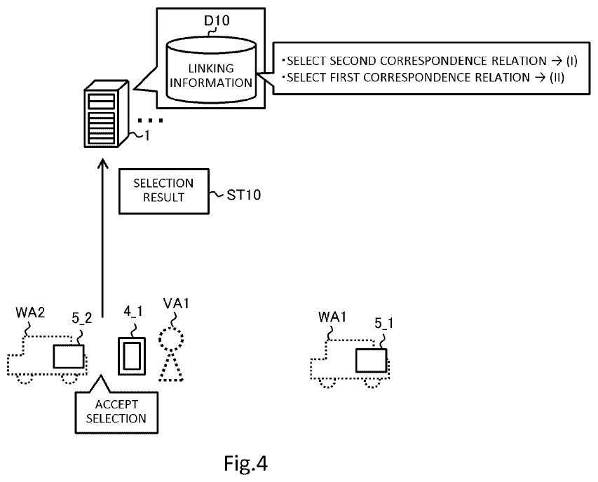

FIG. 4 schematically illustrates an example of the settlement process by the first rule according to the present embodiment. In an example of the present embodiment, the first rule may be compliance with selection by the first target VA. The predetermined rule may include the first rule. In this case, the management server 1 may further be configured to receive a selection result ST10 by the first first target VA1. If the second correspondence relation (second second target WA2) is selected in the received selection result ST10, the management server 1 may (I) release the first correspondence relation, and establish the setting of the second correspondence relation. On the other hand, if the first correspondence relation (first second target WA1) is selected in the received selection result ST10, the management server 1 (II) does not permit the setting of the second correspondence relation, and may maintain the setting of the first correspondence relation.

Note that the selection of the correspondence relation may include direct selection of the correspondence relation to be held, and indirect selection of the correspondence relation to be held through selection of the correspondence relation to be released. The selection of the correspondence relation may include selection of the corresponding second target WA. The selection may be executed by an automatic process by a computer (terminal) or executed manually (by a user's operation).

The selection result ST10 may be generated by at least one of the first first terminal 4_1 of the first first target VA1, and the second second terminal 5_2 of the second second target WA2. In some cases, the selection result ST10 may be generated by the first second terminal 5_1 of the first second target WA1. In the case of manual selection, at least any of the first first terminal 4_1, the first second terminal 5_1, and the second second terminal 5_2 may accept selection at any timing.

The selection result ST10 may be directly or indirectly transmitted to the management server 1 from at least any of the first first terminal 4_1, the first second terminal 5_1, and the second second terminal 5_2. For example, the selection result ST10 may be transmitted from one terminal between the first terminal 4 and the second terminal 5 that has accepted the selection. In another example, the selection result ST10 may be transmitted from another terminal different from the one terminal having accepted the selection between the first terminal 4 and the second terminal 5, through data exchange.

The selection result ST10 may be obtained at any timing before the settlement process is executed. For example, at least any of the first first terminal 4_1, the first second terminal 5_1, and the second second terminal 5_2 may transmit the selection result ST10 to the management server 1 in an autonomous information processing accompanying the linking demand. In another example, at least any of the first first terminal 4_1, the first second terminal 5_1, and the second second terminal 5_2 may transmit, to the management server 1, the selection result ST10 as a reply to a query from the management server 1. The selection result ST10 to be transmitted may be appropriately configured to indicate the selection result by the first first target VA1. According to an example of the present embodiment, the correspondence relation to be held can be selected by a simple process.

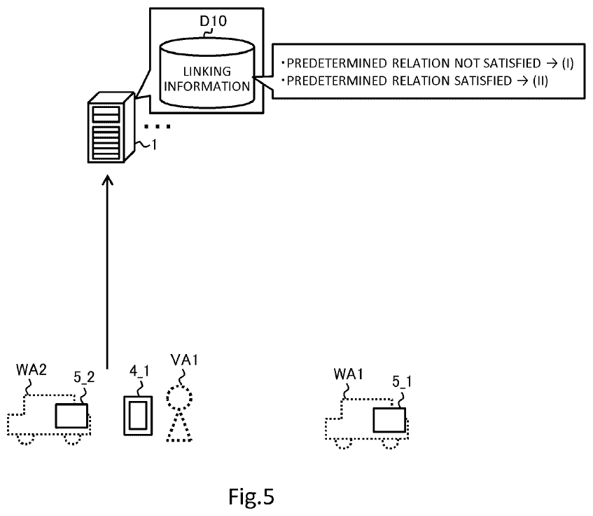

(2) Second Rule FIG. 5 schematically illustrates an example of the settlement process by the second rule according to the present embodiment. In a specific situation, if a predetermined relation is established, setting of the second correspondence relation is not permitted ((II) is selected), and if the predetermined relation is not established, setting of the second correspondence relation is permitted ((I) is selected), thus causing a possibility that the use relation between the first target VA and the second target WA can be appropriately tracked.

For example, if the first second target WA1 is a rental car in the situation in FIG. 2, in view of prohibiting redundant rental during a period of rental of the rental car that is the first second target WA1, setting of a correspondence relation with another rental car as the second second target WA2 is prohibited from being established, thus allowing the use relation to be appropriately tracked in some cases. On the other hand, in a multimodal view, such as parking of a rental car in a parking lot and using a train, even during a rental period of the rental car that is the first second target WA1, establishment of setting of a correspondence relation with another type of mobile body as the second second target WA2 is permitted, thus allowing the use relation to be appropriately tracked in some cases.

In the example described above, the relation between the first second target WA1 and the second second target WA2 is considered as the predetermined relation. However, the relation to be considered is not limited to that between the second targets WA. The relation with the first target VA (first first target VA1) may be considered as the predetermined relation. For example, a situation is assumed where the first target VA and the second target WA are present in the real world, and the use relation is caused by the first target VA and the second target WA coming close. In this situation, if the second second target WA2 (second second terminal 5_2) is apart from the first first target VA1 (first first terminal 4_1) to an extent of satisfying no use relation, the use relation can be appropriately tracked by inhibiting setting the correspondence relation from being established, in some cases. On the other hand, if the second second target WA2 is close to the first first target VA1 to an extent of satisfying the use relation, the use relation can be appropriately tracked by permitting establishment of setting the correspondence relation with the second second target WA, in some cases. As described above, in view of appropriately tracking the use relation, it is sometimes desirable to control whether to inhibit or permit update of the setting of the correspondence relation depending on whether the predetermined relation is established with at least any of the first first target VA1, the first second target WA1, and the second second target WA2.

Accordingly, in an example of the present embodiment, the second rule may inhibit setting of the correspondence relation from being updated depending on establishment of the predetermined relation with at least any of the first first target VA1, the first second target WA1, and the second second target WA2. The predetermined rule may include the second rule. In response to this, if the predetermined relation is not established with at least any of the first first target VA1, the first second target WA1, and the second second target WA2, the management server 1 may (I) release the first correspondence relation, and establish the setting of the second correspondence relation. On the other hand, if the predetermined relation is established with at least any of the first first target VA1, the first second target WA1, and the second second target WA2, the management server 1 (II) does not permit the setting of the second correspondence relation and may maintain the setting of the first correspondence relation.

It may be appropriately determined whether the predetermined relation is established or not depending on an embodiment. Any information may be used for determination. The management server 1 may determine whether the predetermined relation is established or not using information, such as the pieces of target information (O10 and O20), and information obtained from the terminals (4 and 5). If the identifiers (I10 and I20) indicate the attributes of the respective targets (VA and WA), information to be used for determination may include the identifiers (I10 and I20). The information used for determination may be obtained at any timing before the settlement process is executed. The management server 1 may obtain the information from at least any of the external servers (e.g., the first server 2, the second server 3, the external system, etc.) and the terminals (4 and 5). For example, when the information used for determination is obtained from at least one of the first terminal 4 and the second terminal 5, at least one of the first terminal 4 and the second terminal 5 may transmit the information to the management server 1 by an autonomous operation accompanying the linking demand. In another example, at least one of the first terminal 4 and the second terminal 5 may transmit, to the management server 1, the information as a reply to the query from the management server 1. The predetermined relation may be appropriately defined so as to designate the relation where the setting of the correspondence relation is inhibited from being updated, depending on an embodiment.

(2-1) 2-1-th Rule

For example, with a focus on the relation between the second targets WA described above, the 2-1-th rule may be inhibition of updating the setting of the correspondence relation between the second targets WA where the predetermined relation is to be established. The second rule may include the 2-1-th rule. In response to this, if the predetermined relation is not established between the first second target WA1 and the second second target WA2, the management server 1 may (I) release the first correspondence relation, and establish the setting of the second correspondence relation. On the other hand, if the predetermined relation is established between the first second target WA1 and the second second target WA2, the management server 1 (II) does not permit the setting of the second correspondence relation and may maintain the setting of the first correspondence relation. According to an example of the present embodiment, appropriate settlement of a linking setting collision is expected using the relation between the second targets WA.

(2-1-1)

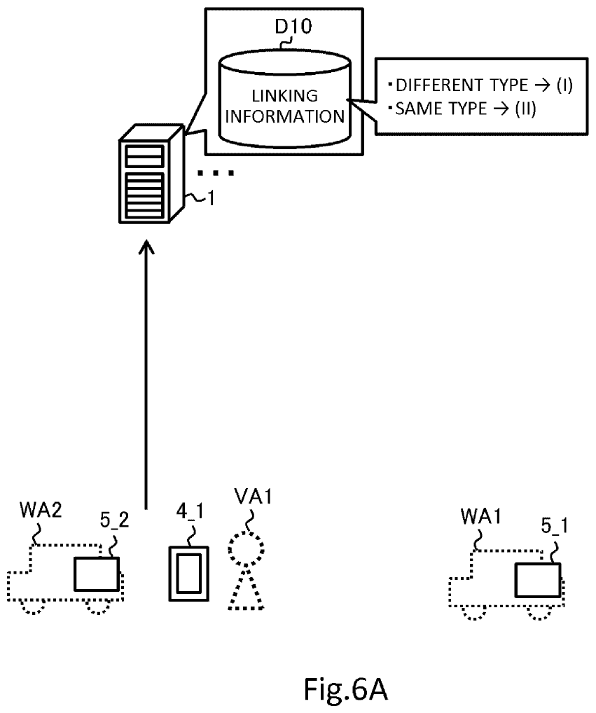

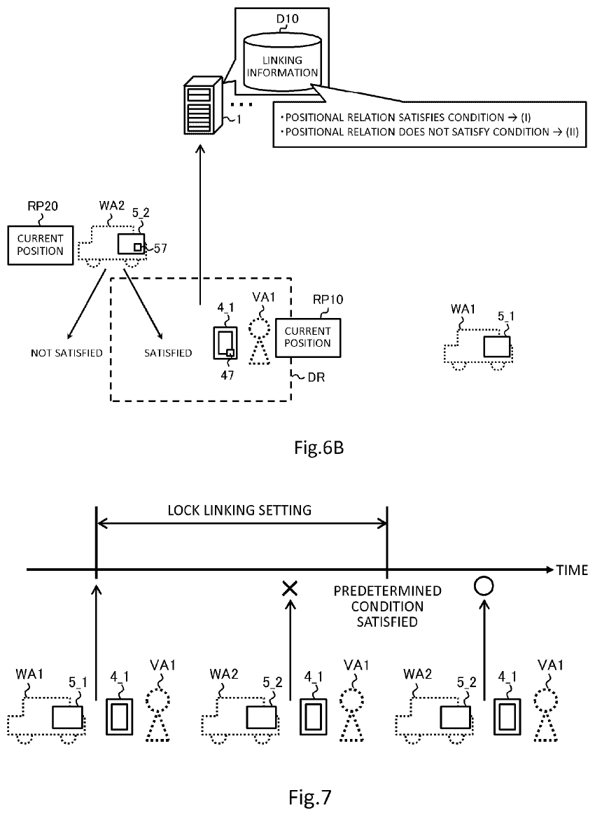

FIG. 6A schematically illustrates an example of a settlement process according to whether a predetermined relation is established or not according to the present embodiment. To address the example of the rental car described above, the predetermined relation between the second targets WA may include identicalness of the type. That is, the 2-1-th rule may include inhibition of updating the setting of the correspondence relation between the second targets WA of the same type, and permission of updating the setting of the correspondence relation between the second targets WA of different types. In response to this, if the type of the second second target WA2 is different from the type of the first second target WA1, the management server 1 may (I) release the first correspondence relation, and establish the setting of the second correspondence relation. On the other hand, if the type of the second second target WA2 is the same as the type of the first second target WA1, the management server 1 (II) does not permit the setting of the second correspondence relation and may maintain the setting of the first correspondence relation.

The types of the second targets (WA1 and WA2) may be determined as required. For example, the types of the second targets (WA1 and WA2) may be determined based on information, such as the second target information O20 (mobile body information O20A) and the second identifier I20. In the example in FIG. 2 described above, the types of the second targets (WA1 and WA2) may be at least any of the aforementioned type description included in the mobile body information O20A, and the mobile body type. According to an example of the present embodiment, appropriate settlement of a linking setting collision is expected using the relation between the types of the second targets WA.

Note that the type as the target of the settlement by this rule may be appropriately selected depending on an embodiment. For example, the first target VA may be a user, and the second target WA may be an object to be used by the user. The 2-1-th rule may include inhibition of updating the setting of the correspondence relation between rental objects. In this case, the fact that they are the rental objects is an example of identicalness of the type. That is, if the second second target WA2 is not a rental object and the type of the first second target WA1 is a rental object, the management server 1 may (I) release the first correspondence relation, and establish the setting of the second correspondence relation. On the other hand, if the type of the second second target WA2 is a rental object, the management server 1 (II) does not permit the setting of the second correspondence relation and may maintain the setting of the first correspondence relation. According to an example of the present embodiment, appropriate settlement of a linking setting collision is expected by inhibiting redundant rental.

The type of object to be used is not necessarily specifically limited, and may be appropriately selected depending on an embodiment. For example, the object to be used may be a vehicle. The rental object may be a rental car. According to an example of the present embodiment, in a situation where a rental car is present, appropriate settlement of a linking setting collision is expected.

Note that there is a situation where the use period (e.g., the contract period of the rental car) is defined depending on the type of the second target WA, such as the rental car. In this situation, if the correspondence relation with the individual concerned among the second targets WA (first correspondence relation) is released during the use period by the process of (I) described above, the management server 1 may hold the setting of the correspondence relation with the individual concerned among the second targets WA (first correspondence relation) until the use period expires. During such holding, after another correspondence relation (second correspondence relation) is released, the management server 1 restores the setting of the correspondence relation with the individual concerned among the second targets WA (first correspondence relation). Thus, the setting of the correspondence relation with the second target WA during the use period can be restored soon.

(2-2) 2-2-th Rule

FIG. 6B schematically illustrates an example of the settlement process according to whether the predetermined relation is established or not according to the present embodiment. For example, with a focus on the relation between the positions of the targets (VA and WA) described above, the 2-2-th rule may be denial of permission for setting the correspondence relation with the second target WA corresponding to the second terminal 5 if the relation of the current positions between the first terminal 4 and the second terminal 5 does not satisfy the condition of the use relation. The second rule may include this 2-2-th rule. The second terminal 5 (second target WA) not being positioned in a range where the use relation between the second terminal 5 (second target WA) and the first terminal 4 (first target VA) is established is an example of the predetermined relation.

In this case, each first terminal 4 may include a positioning module 47. Each second terminal 5 may include a positioning module 57. The management server 1 may be configured to further execute obtaining a current position RP10 of the first first terminal 4_1 measured by the positioning module 47 of the first first terminal 4_1 corresponding to the first first target VA1 from this first first terminal 4_1, and obtaining a current position RP20 of the second second terminal 5_2 measured by the positioning module 57 of the second second terminal 5_2 corresponding to the second second target WA2 from this second second terminal 5_2, upon acceptance of setting of the second correspondence relation. If the relation between the obtained current positions (RP10 and RP20) of the first first terminal 4_1 and the second second terminal 5_2 satisfies the condition of the use relation, the management server 1 may (I) release the first correspondence relation, and establish the setting of the second correspondence relation. On the other hand, if the relation between the obtained current positions (RP10 and RP20) of the first first terminal 4_1 and the second second terminal 5_2 does not satisfy the condition of the use relation, the management server 1 (II) does not permit setting the second correspondence relation, and may maintain the setting of the first correspondence relation.

The condition of the use relation may be appropriately set. For example, the condition of the use relation may be defined by a distance range DR with reference to the current position RP10 of the first first terminal 4_1 or the current position RP20 of the second second terminal 5_2. In this case, depending on presence or absence in the range DR, it may be determined whether the condition of the use relation is satisfied or not. FIG. 6B assumes a situation where the current position RP10 of the first first terminal 4_1 is used as a reference. In this situation, it may be determined that the condition of the use relation is satisfied, by presence of the current position RP20 of the second second terminal 5_2 in the range DR. On the other hand, it may be determined that the condition of the use relation is not satisfied, by presence of the current position RP20 of the second second terminal 5_2 out of the range DR.

Note that the range DR may be appropriately set so as to allow detection of the second target WA with which the use relation is established. The shape of the range DR may be freely defined. The range DR may be defined so that the distance in each direction is identical, or defined so that the distance is different in at least one or some of directions.

The types of the positioning modules (47 and 57) are not necessarily specifically limited, and may be appropriately selected depending on an embodiment. The positioning modules (47 and 57) may be, for example, GPS (Global Positioning Satellite) modules, GNSS (Global Navigation Satellite System) modules, etc.

The current positions (RP10 and RP20) may be transmitted to the management server 1 respectively from the first first terminal 4_1 and the second second terminal 5_2 at any timing before the settlement process is executed. For example, the terminals (4 and 5) may report information on each current position to the management server 1, through autonomous information processing, such as periodical transmission. The terminals (4 and 5) may report, to the management server 1, the information on each current position in conjunction with the linking demand. In this case, the management server 1 may determine whether the condition of the use relation is satisfied or not using the information on the current positions (RP10 and RP20) recently reported from the respective terminals (4_1 and 5_2). In another example, at any timing before the settlement process is executed, the management server 1 may directly or indirectly transmit the request to the first first terminal 4_1 and the second second terminal 5_2. In response to the request, the terminals (4_1 and 5_2) may report the information on the recent current positions (RP10 and RP20) to the management server 1 in real time. The management server 1 may determine whether the condition of the use relation is satisfied or not from the information on the recent current positions (RP10 and RP20) reported in real time. Note that in every form, in case the information on the recent current position of at least one of the first first terminal 4_1 and the second second terminal 5_2 is not obtained owing to an effect, such as of the power being off, the management server 1 may determine that the condition of the use relation is not satisfied.

The report destination of information on each current position may be appropriately selected depending on an embodiment. For example, the report destination of information on each current position may be the management server 1. In response to this, the information on each current position may be managed by the management server 1. In another example, the report destination of the information on each current position may be an external server (the first server 2, the second server 3, etc.). In response to this, the information on each current position may be managed by the external server. The management server 1 may obtain the information on the current positions (RP10 and RP20) from the external server. Reporting to the management server 1 may include direct reporting to the management server 1, and indirect reporting to the management server 1 via the external server. The reported information on each current position may be discarded after it falls out of use, or saved as a history for at least a predetermined period. In the case of adopting the form of directly reporting to the management server 1, the information on each current position may be stored in the management server 1, or stored in an external server (the first server 2, the second server 3, an NAS, etc.). Likewise, also in the case of adopting the form of indirectly reporting to the management server 1, the information on each current position may be stored in the management server 1, or saved in an external server. According to an example of the present embodiment, appropriate settlement of a linking setting collision is expected using the relation between the positions of the first target VA and the second target WA (first terminal 4 and the second terminal 5).

### (3) Third Rule

For example, in the situation in FIG. 2, it is assumed that a correspondence relation (first correspondence relation) is set between a first user serving as the first first target VA1, and a first individual among mobile bodies of a certain public transport system serving as the first second target WA1. In this situation, it is not desirable that even though checkout for the mobile body of the public transport system has not been completed, use of another mobile body by the first user releases the first correspondence relation with the first individual of the mobile body, and establishes setting of a new correspondence relation with the other mobile body. The other mobile body is an example of the second second target WA2 (second individual of the mobile body). As described above, if the individual concerned among the second targets WA is of a predetermined type, it is sometimes desirable that until fulfilment of the predetermined condition (until completion of checkout in the example described above), establishment of setting of the correspondence relation with another individual among the second targets WA be denied.

Accordingly, in an example of the present embodiment, the management server 1 is further configured to inhibit release of the correspondence relation by locking the setting of the correspondence relation until the predetermined condition is satisfied, if the correspondence relation is set with the predetermined type of the second target WA. The third rule may be inhibition of updating the setting of the correspondence relation while the setting of the correspondence relation is locked. The predetermined rule may include the third rule.

FIG. 7 schematically illustrates an example of a situation where linking setting is locked according to the present embodiment. If the predetermined condition is not satisfied with the first second target WA1 being of the predetermined type, when setting of the second correspondence relation is accepted while the first correspondence relation is locked, the management server 1 (II) does not permit the setting of the second correspondence relation, and may maintain the setting of the first correspondence relation. That is, the management server 1 may ignore the linking demand with the second second target WA2. At this time, the management server 1 may directly or indirectly transmit a notification indicating that setting of another correspondence relation is inhibited, to at least one of the first first terminal 4_1 of the first first target VA1 and the second second terminal 5_2 of the second second target WA2. On the other hand, if the setting of the second correspondence relation is accepted after the locking of the first correspondence relation is released owing to fulfilment of the predetermined condition, the management server 1 may (I) release the first correspondence relation, and establish setting of the second correspondence relation.

The predetermined condition may be appropriately set depending on an embodiment. It may be appropriately detected whether the predetermined condition is satisfied or not. In a simple example, fulfillment of the predetermined condition may be detected based on a notification from the second terminal 5 corresponding to the individual concerned of the predetermined type of second target WA. In the example described above, when checkout is completed, the second terminal 5 as the individual concerned of the mobile body (first second terminal 5_1) may transmit a notification indicating completion of checkout (fulfillment of the predetermined condition) to the management server 1. The management server 1 may detect fulfillment of the predetermined condition by receiving the notification. The management server 1 may then release the lock of the setting of the correspondence relation with the second target WA in response to detection of the fulfillment of the predetermined condition. Accordingly, the management server 1 may permit establishment of the setting of a new correspondence relation with another individual of the second target WA. Note that the management server 1 may execute such a locking process also for the second target WA of another type different from the predetermined type, or omit execution of the locking process, for the second target WA of another type. According to an example of the present embodiment, if establishment of setting of another correspondence relation is inappropriate, the established setting of the correspondence relation is locked, which can inhibit establishment of such setting of another correspondence relation. Thus, appropriate settlement for a linking setting collision can be expected.

Note that the predetermined type may be appropriately selected depending on the embodiment. For example, the first target VA may be the user. The second target WA of the predetermined type may be a mobile body of a public transport system. The predetermined condition may be completion of payment (checkout) of a charge for use of the mobile body of the public transport system. According to an example of the present embodiment, if the charge for the mobile body of the transport system is unpaid, transfer to another mobile body (establishment of setting of a new correspondence relation with another mobile body) can be inhibited. Thus, appropriate settlement for a linking setting collision can be expected.

### (Use Continuation Checking Process)

According to an optional configuration, after setting the correspondence relation between the individual concerned among the first targets VA and the individual concerned among the second targets WA, the management server 1 may further execute a process for checking whether the correspondence relation is continued or not (checking process). The use continuation checking process may be appropriately selected depending on an embodiment.

For example, the continuation of the correspondence relation may be checked by authenticating at least one of the first target VA and the second target WA via at least one of the first terminal 4 and the second terminal 5. Similarly to the linking setting and the like, the authentication method may be performed by any method. In the example in FIG. 2, for example, the user may be authenticated by a method, such as of performing authentication of the user's face using an image sensor included in the mobile body, of performing authentication of the user's fingerprint using a fingerprint reading device attached to a steering wheel, or of causing the user to speak and performing voiceprint authentication using a microphone included in the mobile body. The authentication processing may be executed at least any of the terminals (4 and 5), the servers (2 and 3), and the management server 1. In the case of executing the authentication processing at the server (2, 3), data to be used for authentication may be directly transmitted from the terminal (4, 5) to the server (2, 3) or indirectly transmitted via an external computer, such as the management server 1. In the case of executing the authentication processing at the management server 1, data to be used for authentication may be directly transmitted from the terminal (4, 5) to the management server 1, or indirectly transmitted via an external computer, such as the server (2, 3). The management server 1 may obtain an authentication result as required, and may determine that the correspondence relation is continued if authentication of the target is achieved in the obtained authentication result, and determine that the correspondence relation is not continued if the authentication is not achieved.

In another example, in the case where at least one of the first target VA and the second target WA is the user (e.g., the case in FIG. 2), the management server 1 may directly or indirectly transmit a checking notification including an operation piece to at least one of the first terminal 4 and the second terminal 5. The operation piece may be made up of, for example, a checking button, a reply button, a link, etc. The transmission destination of the checking notification does not necessarily correspond to the user. In the case in FIG. 2, the management server 1 may transmit the checking notification to at least one of the first terminal 4 and the second terminal 5. The transmission destination of the checking notification may be identical to or different from the transmission destination of the notification indicating the result of the process related to linking. As for the checking notification, it may be configured so that a reply is directly or indirectly returned to the management server 1 in response to an operation on the operation piece by the user. The management server 1 may determine that the correspondence relation is continued if receiving the reply by the operation on the operation piece within a predetermined period, and determine that the correspondence relation is not continued if receiving no reply.

In still another example, in a case of tracking the correspondence relation between the first target VA and the second target WA in the real world, the terminals (4 and 5) may include the respective positioning modules (47 and 57) as in the example in FIG. 6B. The first terminal 4 may measure the current position of the first target VA (first terminal 4) through the positioning module 47. The second terminal 5 may measure the current position of the second target WA (second terminal 5) through the positioning module 57. The terminals (4 and 5) may transmit the current positions of the obtained respective targets (VA and WA) to the management server 1 directly, or indirectly via an external computer, such as the server (2, 3). The management server 1 may determine whether the correspondence relation is continued or not depending on whether the received current positions of the targets (VA and WA) are close to each other to an extent of satisfying the predetermined condition of the use relation (for example, the user is in the vehicle) or not. That is, the management server 1 may determine that the correspondence relation is continued if the current positions of the targets (VA and WA) are close to each other to the extent of satisfying the predetermined condition, and determine that the correspondence relation is not continued if not. Note that in a case of adopting this form, the management server 1 may store information on the obtained current positions of the targets (VA and WA) in association with the linking information D10. Accordingly, the management server 1 can track the movement histories of the targets (VA and WA) besides the correspondence relation of the targets (VA and WA). At least part of the process described above may be executed by a computer other than the management server 1.

If determining that the correspondence relation is continued, the management server 1 may maintain the setting of the correspondence relation. On the other hand, if determining that the correspondence relation is not continued, the management server 1 may release the correspondence relation. The management server 1 may be configured to update the state of the correspondence relation by regularly or irregularly repetitively executing the checking process until the correspondence relation is released, after the correspondence relation is set.

### (Linking Release)

In the present embodiment, the management server 1 may be configured to release the correspondence relation in response to receipt of the release demand issued from at least one of the first terminal 4 and the second terminal 5, or fulfilment of the predetermined release condition.

### (I) Release Demand

For example, the release demand may be configured to indicate the correspondence relation of the release targets by including at least any of the first identifier I10 and the second identifier I20. In another example, the release demand may be configured to indicate the correspondence relation between the release targets by including alternative information.

In a case where the first terminal 4 transmits the release demand including the second identifier I20, the first terminal 4 may obtain the second identifier I20 at any timing. For example, at the linking demand, the first terminal 4 may obtain the second identifier I20, and store the obtained second identifier I20 in the memory resource. At the release demand, the first terminal 4 may obtain the second identifier I20 from the memory resource. When the first terminal 4 transmits the release demand including the first identifier I10, the first terminal 4 may obtain the first identifier I10 at any timing. For example, the first identifier I10 may be preliminarily stored in the memory resource. The first terminal 4 may obtain the first identifier I10 from the memory resource.

Likewise, in a case where the second terminal 5 transmits the release demand including the first identifier I10, the second terminal 5 may obtain the first identifier I10 at any timing. For example, at the linking demand, the second terminal 5 may obtain the first identifier I10, and store the obtained first identifier I10 in the memory resource. At the release demand, the second terminal 5 may obtain the first identifier I10 from the memory resource. When the second terminal 5 transmits the release demand including the second identifier I20, the second terminal 5 may obtain the second identifier I20 at any timing. For example, the second identifier I20 may be preliminarily stored in the memory resource. The second terminal 5 may obtain the second identifier I20 from the memory resource.

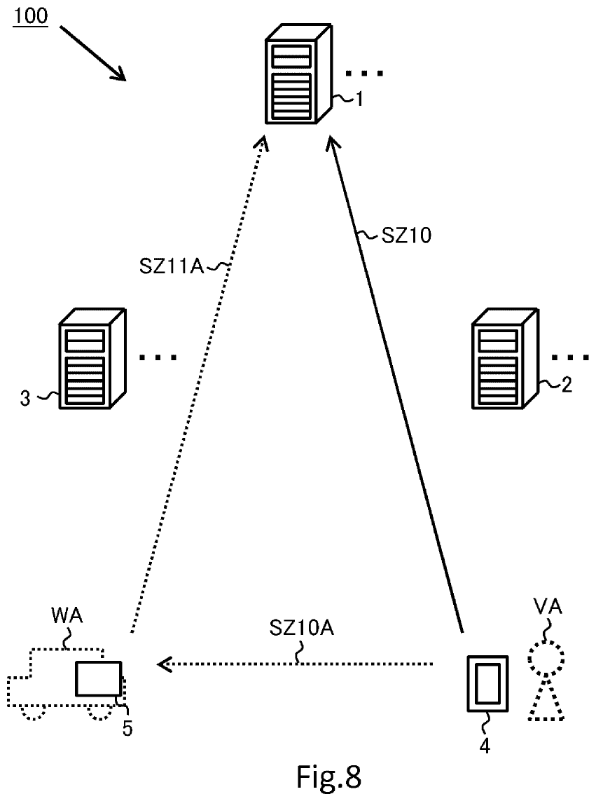

FIG. 8 schematically illustrates an example of a procedure of releasing linking according to the present embodiment. In the example in FIG. 8, along a first route, the first terminal 4 directly transmits the release demand to the management server 1 (step SZ10). Along a second route, the first terminal 4 provides an instruction for the second terminal 5 (step SZ10A), and causes the second terminal 5 to directly transmit the release demand to the management server 1 (step SZ11A). Note that the transmission route for the release demand is not necessarily limited to such an example. The first terminal 4 may indirectly transmit the release demand to the management server 1 via an external computer, such as the first server 2. On the second route, the second terminal 5 may indirectly transmit the release demand to the management server 1 via an external computer, such as the second server 3. Note that the originating point of the release demand is not necessarily limited to the first terminal 4. In another example, the second terminal 5 may directly or indirectly transmit the release demand to the management server 1. The second terminal 5 may provide an instruction for the first terminal 4, and cause the first terminal 4 to transmit the release demand directly or indirectly to the management server 1. After receipt of the release demand, the management server 1 refers to the linking information D10, and releases the correspondence relation designated by the identifier included in the release demand. Similarly to the case of the linking setting, after a release process, the management server 1 may transmit a notification indicating the result of the release process to at least one of the first terminal 4 and the second terminal 5.

The trigger of the release demand may be appropriately set depending on the embodiment. For example, in a case where at least one of the first target VA and the second target WA is the user, through an operation by the user on at least one of the first terminal 4 and the second terminal 5, the release demand may be transmitted from at least one of the first terminal 4 and the second terminal 5. That is, the trigger of the release demand may be the operation by the user. In another example, in response to extinction of the use relation, optional information processing may be executed in at least one of the first terminal 4 and the second terminal 5. With execution of the information processing as a trigger, the release demand may be transmitted from at least one of the first terminal 4 and the second terminal 5. For example, optional information processing may be data exchange between the first terminal 4 and the second terminal 5. The method of data exchange at linking release may be similar to the data exchange at linking setting. The data exchange at linking setting and the data exchange at linking release may be appropriately distinguished from each other. For example, in the example in FIG. 2, as in cases of a platform of a bus, and a railroad ticket gate, the second terminal 5 may include sensor devices separately provided at an entrance and an exit. In this case, depending on the sensor devices used for data exchange, the data exchange at linking setting, and the data exchange at linking release can be distinguished from each other. For example, in a case where data exchange is executed by an application in the terminal, the application may be configured to be switchable between a linking setting mode and a linking release mode. Here, depending on the mode of the application, the linking setting case and the linking release case may be distinguished from each other.

For example, upon acceptance of the release demand about the correspondence relation during the setting of the correspondence relation being locked by the locking process described above, the management server 1 may discard the accepted release demand. The management server 1 may directly or indirectly transmit a notification indicating that release of the correspondence relation is inhibited, to at least one of the first terminal 4 and the second terminal 5. On the other hand, after the locking is released owing to fulfilment of the predetermined condition, the management server 1 may accept the release demand, and release the correspondence relation. For example, the management server 1 may detect the fulfilment of the predetermined condition in response to extinction of the use relation. For example, the release demand may include information indicating the fulfilment of the predetermined condition. In another example, before the release demand, the information indicating the fulfilment of the predetermined condition may be transmitted to the management server 1. Accordingly, the management server 1 may accept the release demand transmitted in response to extinction of the use relation, and release the correspondence relation designated by the release demand.

### (II) Release Condition

The release condition indicates a condition for releasing the correspondence relation of the targets. The release condition may be appropriately defined depending on the embodiment.

For example, the release condition may be defined so as to release the correspondence relation at an arbitrarily set release time. The release time may be provided by, for example, designation by the user, designation from another application (scheduler etc.), or the like. In this case, the management server 1 may release the correspondence relation of targets as the release time is reached. The release time may be set as an expiration period of the linking information D10 described above. In the case where the release time is set with the expiration period, the management server 1 may assume that the correspondence relation of targets is released as the release time is reached.

In another example, the number of correspondence relations settable for the identical individual among the second targets WA may be infinite or finite. In the case where the number of settable correspondence relations is finite, the number of correspondence relations settable for the identical individual among the second targets WA may have an upper limit value (threshold). The threshold may be appropriately provided. If the number of correspondence relations set for the individual concerned among the second targets WA exceeds this upper limit value, the management server 1 may release at least any of the correspondence relations set for the individual concerned among the second targets WA. It may be appropriately determine which correspondence relation is released depending on the priority, the order, the type of target, etc. The management server 1 may transmit a query about release of at least one of the first terminal 4 and the second terminal 5, and determine the correspondence relation to be released depending on an obtained reply.

For example, as in the example in FIG. 2, a situation where the first target VA is a user, and the second target WA is an object to be used is assumed. In this case, the number of users that can be linked to the identical object to be used may be infinite or finite. In the case where the number of users that can be linked is finite, the upper limit value of the number of users that can be linked may be provided as a threshold. The threshold may be set depending on the attribute of the object to be used (e.g., the number of available passengers). Upon new acceptance of the setting of the correspondence relation for the individual concerned of the object to be used, the management server 1 may refer to the linking information D10, and extract the previous correspondence relations set and maintained for the individual concerned of the object to be used. If the number of redundant settings of the correspondence relation for the individual concerned of the object to be used exceeds a threshold by the newly accepted setting of the correspondence relation, the management server 1 may discard the newly accepted request for the setting of the correspondence relation, or release at least any of the extracted previous correspondence relations. If the previous correspondence relation is released, the management server 1 may determine the correspondence relation to be released depending on the priority by the user, the order (for example, the more previously the correspondence relation is set, the more preferentially the release is applied).

In a specific example, in the example in FIG. 2, the mobile body is a private car, and the first user and the second user are, for example, family members, thus assuming that the target private car is shared. The private car may read as being an object to be regularly used. For the sake of description convenience, the number of users that can be linked to the target private car is assumed as one. In this case, with setting of the correspondence relation between one of the first user and the second user, and the private car as the target, upon acceptance of the setting of the correspondence relation between the other and the target private car, the management server 1 may release the previous correspondence relation (the correspondence relation between the one and the target private car).

As described above, the management server 1 may release the correspondence relation in response to receipt of the release request issued by at least one of the first terminal 4 and the second terminal 5, or fulfilment of the predetermined release condition. According to an example of the present embodiment, the use relation between the first target VA and the second target WA can be tracked. Note that the linking information D10 after the correspondence relation is released may be stored as a history.

### (Use Situation of Linking Information)

As described above, the linking information D10 may be used in various situations. For example, the linking information D10 may be used to simply track occurrence and extinction of the relation between the first target VA and the second target WA.

In another example, the linking information D10 may be used to allow exercising at least part of the authority linked to at least one of the first target VA and the second target WA while the correspondence relation between the first target VA and the second target WA is set, from the other. For example, it may be configured so that in response to establishment of the correspondence relation between the first target VA and the second target WA, the management server 1 further executes activation of exercising the authority associated with the corresponding first target VA through the second target WA with which the correspondence relation is set. The management server 1 may be configured to further execute inactivation of exercising the authority, in response to release of the correspondence relation. In the example in FIG. 2, the linking information D10 may be used to allow the mobile body to exercise at least part of the authority linked to the user while the correspondence relation is set between the user and the mobile body. According to an example of the present embodiment, by setting and releasing the correspondence relation, permission and inhibition of exercising the authority of the first target VA can be controlled by the second target WA.

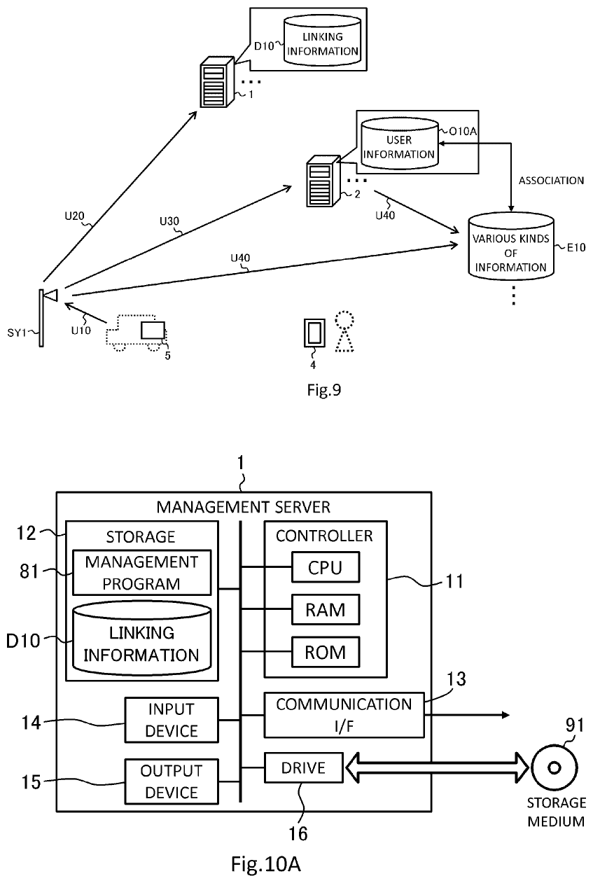

FIG. 9 schematically illustrates an example of a situation of using the linking information D10 according to the present embodiment. FIG. 9 assumes a situation where in the example in FIG. 2, the authority linked to the user is exercised from the mobile body. It is assumed that the linking information D10 includes the first identifier I10 and the second identifier I20, thus indicating the first target VA (user) and the second target WA (mobile body) between which the correspondence relation is set. Furthermore, a situation is assumed where information on the user is managed by the first server 2, and information on the mobile body is managed by the second server 3. An external system SY1 is installed at a place where various services are exercised (e.g., a parking lot etc.), and is configured to execute information processing for providing a target service for the user having the authority of the target. The configuration and the service of the external system SY1 are not necessarily specifically limited, and may be appropriately selected depending on an embodiment.

First, in step U10, the external system SY1 may obtain the second identifier I20 (mobile body identifier) from the target mobile body. The method of obtaining the second identifier I20 may be appropriately selected depending on an embodiment. For example, the external system SY1 may obtain the second identifier I20 from the second terminal 5 by exchanging data with this second terminal 5. The method of data exchange may be similar to data exchange between the first terminal 4 and the second terminal 5. In another example, in the case where the second identifier I20 is a vehicle registration number, the external system SY1 may obtain the second identifier I20 by taking an image of a license plate through an image sensor, and analyzing the obtained image.

In step U20, the external system SY1 may inquire of the management server 1 whether the target mobile body has an effective correspondence relation at a target date and time or not using the obtained second identifier I20 as a query. “Effective” indicates that the setting of the correspondence relation is maintained at the target date and time. Basically, the target date and time is the current time (real time), but is not necessarily limited thereto. For example, in a case of executing a payment process at a past date and time, the target date and time may be the past date and time. If an effective correspondence relation is present, the first identifier I10 (user identifier) of the user linked to the target mobile body is extracted. On the other hand, if an effective correspondence relation is absent, and no user linked to the target mobile body is extracted, this process may be finished.

In step U30, the external system SY1 may use the extracted first identifier I10 as a query, and inquire of the first server 2 the exercisable authority with respect to the user linked to the target mobile body. The first server 2 may refer to the first target information O10 (user information O10A), and extract an exercisable authority associated with the target user. If the exercisable authority is not extracted, this process may be finished. Note that in the first target information O10 (user information O10A), it may be set whether to permit the mobile body to exercise the authority or not on an authority-by-authority basis. According to the setting, the exercisable authority may be extracted. Also, if the target authority that the external system SY1 intends to exercise is not included in the exercisable authority, this process may be finished. The authority to be exercised may be appropriately designated at any timing. For example, the authority to be exercised may be preliminarily designated in the external system SY1, and may be designated by the user.

In step U40, if the target authority is included in the exercisable authority, the external system SY1 may execute a process for exercising the target authority. Accordingly, the authority linked to the user is exercised from the mobile body, and the user can accept a service through the mobile body. For example, if the authority information includes information on public personal authentication, and the target authority relates to the public personal authentication, the user can accept a public service through the mobile body. For example, if the authority information includes payment information, and the target authority relates to payment, the user can accept a payment service through the mobile body. The payment service may be, for example, payment for a charge, such as payment for a parking lot usage charge, an expressway charge, a drive-through charge, a public transportation charge, or a rental charge. For example, if the authority information includes information about an electronic prescription, and the target authority is reception of medications prescribed through the electronic prescription, the user can redeem the electronic prescription through the mobile body, and receive the medications.

Note that for example, in a case where a plurality of users use an individual of the mobile body, such as a case where the users are in the identical vehicle, a user to exercise the authority can be appropriately selected. For example, by establishing the setting of the correspondence relation of one user among the users using the identical individual of the mobile body, the user to exercise the authority may be selected. In another example, setting of the correspondence relation of two or more users among the users using the identical individual of the mobile body may be established. In this case, the method of exercising the authority may be appropriately adjusted among two or more users where the correspondence relations are set. For example, the authority of one or more selected users (representatives) can be exercised. The users may be selected by at least any of the external system SY1, the first terminal 4, and the second terminal 5. For example, in the case where the exercise of the authority is payment for a charge, the authority of each user may be exercised according to a predetermined rule. In a specific example, the amount of payment may be equally shared among the users. For payment for each assigned amount, the authority of each user may be exercised. The amounts assigned among the users may be appropriately designated.

In another example, a group may be preliminarily set among users, and priorities may be assigned to the members (users) in the group. For example, in a case where a private car is used by a family, one group may be set for one family, and priorities may be set depending on the relation in the family. For example, the priorities of parents may be set high, and the priorities of children may be set low. Information on the group and priorities may be appropriately managed according to, for example, the first target information O10 (user information O10A) or the like. Accordingly, setting of the correspondence relation of two or more users in the same group among the users using the identical individual of the mobile body may be established. In this case, depending on the priority, the authority of each user may be exercised. For example, in a case where parents and children use a private car, and the priorities of the parents are set high, the authorities of the parents may be exercised. Exercising the authority depending on the priority may include selection of a user to exercise the authority depending on the priority (the higher the priority the user has, the more they are selected as targets to execute the authority), and determination of the weight for exercising the authority depending on the priority (for example, the higher the priority the user has, the higher the payment amount is assigned).

The processing procedure when the authority described above is exercised is only an example. Each step may be changed as much as possible. In the processing procedure described above, steps may be appropriately omitted, replaced, and added depending on an embodiment. In the processing procedure described above, the user may be replaced with the first target VA, and the mobile body may be replaced with the second target WA. Furthermore, in the processing procedure described above, “first” and “second” may be replaced with each other.

### (Data Communication Between Apparatuses)

Data communication between the apparatuses (the management server 1, the first server 2, the second server 3, the first terminal 4, and the second terminal 5) is not necessarily specifically limited, and may be appropriately selected depending on an embodiment. A network among the apparatuses may be appropriately selected from among, for example, the Internet, a wireless communication network, a mobile communication network, a telephone network, a dedicated network, a local area network, etc. Data communication among the apparatuses may be encrypted by a method, such as of SSL (Secure Socket Layer), or TLS (Transport Layer Security). For example, the terminals (4 and 5) may each include a SIM (Subscriber Identity Module), and data communication among the terminals (4 and 5), and the servers (the management server 1, the first server 2, and the second server 3) may be performed by encrypted communication using the SIMs.

### [2 Configuration Example]

### [Hardware Configuration Example]

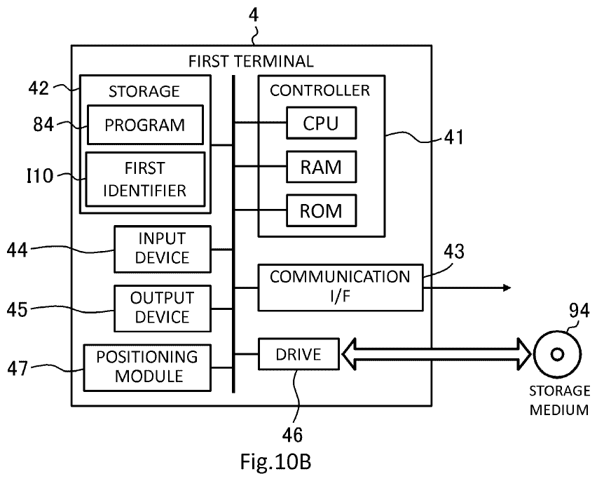

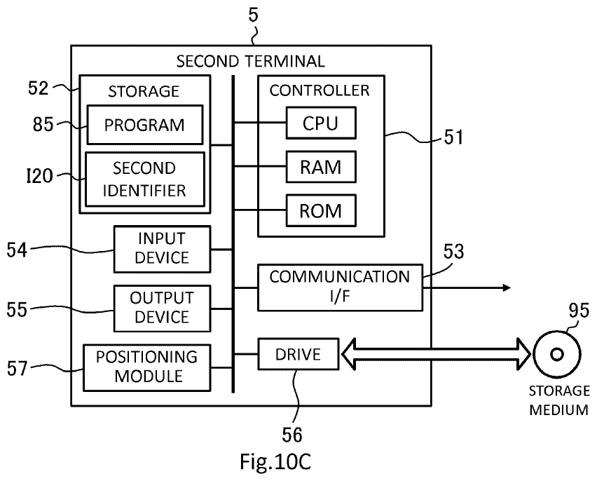

(Management Server) FIG. 10A schematically illustrates an example of the hardware configuration of the management server 1 according to the present embodiment. The management server 1 according to the present embodiment is a computer that includes a controller 11, a storage 12, a communication interface 13, an input device 14, an output device 15, and a drive 16, which are electrically connected to each other.

The controller 11 includes a CPU (Central Processing Unit) as a hardware processor, a RAM (Random Access Memory), and a ROM (Read Only Memory), and is configured to execute any information processing, based on programs and various data items. The controller 11 (CPU) is an example of a processor resource of the management server 1.

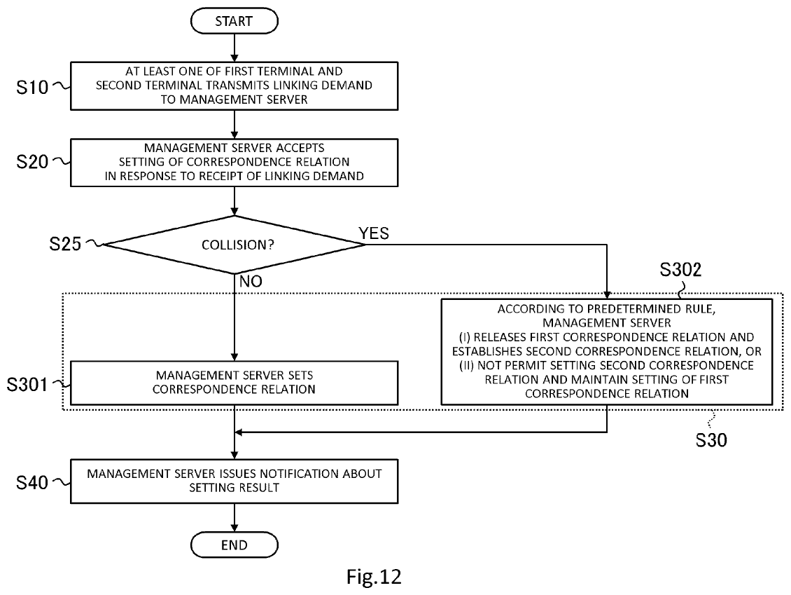

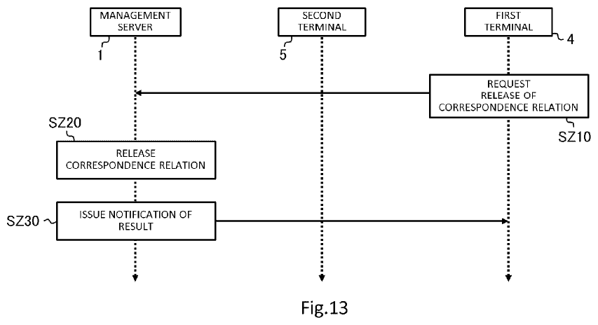

The storage 12 may be made up of, for example, a hard disk drive, a solid-state drive, a semiconductor memory, or the like. The storage 12 (and a RAM and a ROM) is an example of the memory resource. In the present embodiment, the storage 12 stores various types of information, such as a management program 81, and the linking information D10. The management program 81 is a program for causing the management server 1 to execute information processing (FIGS. 12 and 13 described later) related to setting and release of the correspondence relation between the first target VA and the second target WA. The management program 81 includes a series of commands of the information processing.

The communication interface 13 is configured to perform wired or wireless communication via a network. The communication interface 13 may be made up of, for example, a wired LAN (Local Area Network) module, a wireless LAN module, or the like. The management server 1 may execute data communication with another computer (the first server 2, the second server 3, the first terminal 4, and the second terminal 5) via the communication interface 13.

The input device 14 is, for example, a device for inputting, such as a mouse, a keyboard, and an operation button. The output device 15 is, for example, a device for outputting, such as a display and a speaker. The operator can operate the management server 1 using the input device 14 and the output device 15. The input device 14 and the output device 15 may be integrally made up of, for example, a touch panel display or the like. The input device 14 and the output device 15 may be connected via an external interface. The external interface may be appropriately configured to be connected to an external apparatus wired or wirelessly to an external apparatus via, for example, a USB (Universal Serial Bus) port, a dedicated port, a wireless communication port or the like.

The drive 16 is a device for reading various types of information, such as programs, stored in a storage medium 91. At least one of the management program 81 and the linking information D10 may be stored in the storage medium 91 instead of the storage 12 or in conjunction with the storage 12. The storage medium 91 is configured to accumulate various types of information (stored programs etc.) through electrical, magnetic, optical, mechanical, or chemical action so as to allow a machine, such as a computer, to read the information concerned. The management server 1 may obtain at least one of the management program 81 and the linking information D10 from the storage medium 91. Note that the storage medium 91 may be a disk-shaped storage medium, such as a CD or a DVD, or a storage medium other than the disk-shaped one, such as a semiconductor memory (e.g., a flash memory). The type of the drive 16 may be appropriately selected depending on the type of the storage medium 91. The drive 16 may be connected via an external interface.

Note that as for the specific hardware configuration of the management server 1, components can be appropriately omitted, replaced, and added depending on an embodiment. For example, the controller 11 may include a plurality of hardware processors. The hardware processors may be made up of, an FPGA (field-programmable gate array), a DSP (digital signal processor), a GPU (Graphics Processing Unit), and an ASIC (application specific integrated circuit), etc. At least any of the input device 14, the output device 15, and the drive 16 may be omitted. The linking information D10 may be stored in an external computer (e.g., an NAS etc.) that the management server 1 can access, instead of the storage 12. The management server 1 may include a plurality of computers. In this case, the hardware configurations of the computers may be identical to each other or not. The management server 1 may be an information processing apparatus designed specifically for a service to be provided, or may be a general-purpose server apparatus, a general-purpose computer, or the like.

### (First Server and Second Server)

The hardware configuration of each server (2, 3) may be similar to that of the management server 1. For example, each server (2, 3) may be a computer that includes a controller, a storage, a communication interface, an input device, an output device, and a drive, which are electrically connected to each other. Each server (2, 3) may be made up of one or more computer apparatuses. The processor resource of each server (2, 3) may be made up of one or more processors. The type of the processor may be appropriately selected. The first target information O10 may be stored in at least any of the memory resource of the first server 2, and an external computer (an NAS etc.) that the first server 2 can access. The second target information O20 may be stored in at least any of the memory resource of the second server 3, and an external computer (an NAS etc.) that the second server 3 can access. As for the hardware configuration of each server (2, 3), components can be appropriately omitted, replaced, and added depending on the embodiment. Each server (2, 3) may be an information processing apparatus designed specifically for a service to be provided, or may be a general-purpose server apparatus, a general-purpose computer, or the like.

### (First Terminal)

FIG. 10B schematically illustrates an example of the hardware configuration of the first terminal 4 according to the present embodiment. The first terminal 4 according to the present embodiment is a computer that includes a controller 41, a storage 42, a communication interface 43, an input device 44, an output device 45, a drive 46, and the positioning module 47, which are electrically connected to each other. The controller 41 to the drive 46 of the first terminal 4, and a storage medium 94 may be configured similarly to the controller 11 to the drive 16, and the storage medium 91 of the management server 1.

The controller 41 (CPU) is an example of the processor resource of the first terminal 4, and the storage 42 (and a RAM and a ROM) is an example of the memory resource of the first terminal 4. In the present embodiment, the storage 42 stores various types of information, such as a program 84, and the link information D10. The program 84 is a program for causing the first terminal 4 to execute information processing (FIGS. 12 and 13 described later) related to linking. The program 84 includes a series of commands of the information processing. At least one of the program 84 and the first identifier I10 may be stored in the storage medium 94 instead of the storage 42 or in conjunction with the storage 42. The first terminal 4 may obtain at least one of the program 84 and the first identifier I10 from the storage medium 94. The first terminal 4 may execute data communication with another computer (the management server 1, the first server 2, the second server 3, the second terminal 5, etc.) via the communication interface 43. The first terminal 4 may be operated through the input device 44 and the output device 45.

Note that as for the specific hardware configuration of the first terminal 4, components can be appropriately omitted, replaced, and added depending on an embodiment. For example, the controller 41 may include a plurality of hardware processors. The hardware processor may be made up of a microprocessor, an FPGA, a DSP, a GPU, an ASIC, an ECU (Electronic Control Unit), etc. At least any of the input device 44, the output device 45, the drive 46, and the positioning module 47 may be omitted. The first identifier I10 is not necessarily stored in the storage 42. The first identifier I10 may be obtained as required. To obtain data, such as identifiers, and information required for authentication, the first terminal 4 may further include a data obtaining device, such as a sensor and a reading device. The communication interface 43 may be made up of multiple types of modules. For example, the communication interface 43 may include a short-range wireless communication module, and a wireless communication module. The first terminal 4 may perform data communication with the second terminal 5 through the short-range wireless communication module, and perform data communication with the server (the management server 1, the first server 2, and the second server 3) through the wireless communication module. The first terminal 4 may include a plurality of computers. In this case, the hardware configurations of the computers may be identical to each other or not. The first terminal 4 may be an information processing apparatus designed specifically for a service to be provided, or may be a general-purpose computer, a terminal apparatus (e.g., a smartphone, a tablet PC, etc.), or the like.

### (Second Terminal)

FIG. 10C schematically illustrates an example of the hardware configuration of the second terminal 5 according to the present embodiment. The second terminal 5 according to the present embodiment is a computer that includes a controller 51, a storage 52, a communication interface 53, an input device 54, an output device 55, a drive 56, and the positioning module 57, which are electrically connected to each other. The controller 51 to the drive 56 of the second terminal 5, and a storage medium 95 may be configured similarly to the controller 11 to the drive 16, and the storage medium 91 of the management server 1.

The controller 51 (CPU) is an example of the processor resource of the second terminal 5, and the storage 52 (and a RAM and a ROM) is an example of the memory resource of the second terminal 5. In the present embodiment, the storage 52 stores various types of information, such as a program 85, and the second identifier I20. The program 85 is a program for causing the second terminal 5 to execute information processing (FIGS. 12 and 13 described later) related to linking. The program 85 includes a series of commands of the information processing. At least one of the program 85 and the second identifier I20 may be stored in the storage medium 95 instead of the storage 52 or in conjunction with the storage 52. The second terminal 5 may obtain at least one of the program 85 and the second identifier I20 from the storage medium 95. The second terminal 5 may execute data communication with another computer (the management server 1, the first server 2, the second server 3, the second terminal 5, etc.) via the communication interface 53. The second terminal 5 may be operated through the input device 54 and the output device 55.

Note that as for the specific hardware configuration of the second terminal 5, components can be appropriately omitted, replaced, and added depending on an embodiment. For example, the controller 51 may include a plurality of hardware processors. The hardware processor may be made up of a microprocessor, an FPGA, a DSP, a GPU, an ASIC, an ECU, etc. At least any of the input device 54, the output device 55, the drive 56, and the positioning module 57 may be omitted. The second identifier I20 is not necessarily stored in the storage 52. The second identifier I20 may be obtained as required. To obtain data, such as identifiers, and information required for authentication, the second terminal 5 may further include a data obtaining device, such as a sensor and a reading device. Similarly to the case of the first terminal 4 described above, the communication interface 53 may be made up of multiple types of modules. The second terminal 5 may include a plurality of computers. In this case, the hardware configurations of the computers may be identical to each other or not. The second terminal 5 may be an information processing apparatus designed specifically for a service to be provided, or may be a general-purpose computer, a terminal apparatus, or the like.

### [Software Configuration Example]

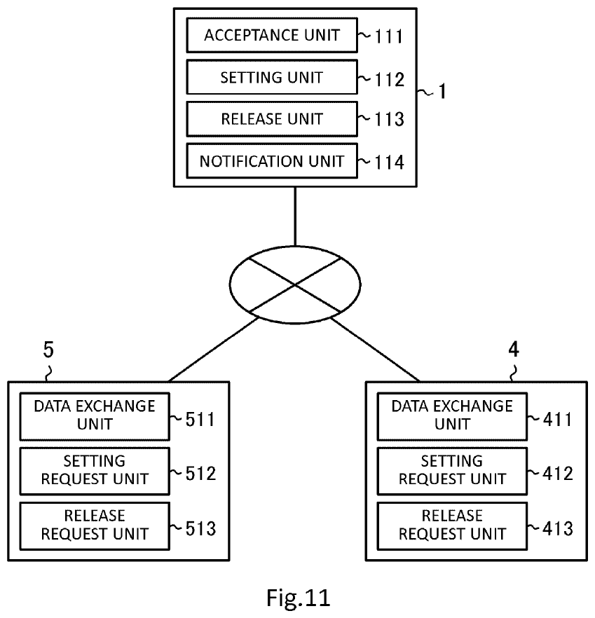

FIG. 11 schematically illustrates an example of a software configuration of each apparatus (the management server 1, the first terminal 4, and the second terminal 5) according to the present embodiment.

### (Management Server)

The controller 11 of the management server 1 loads the management program 81 stored in the storage 12 onto the RAM, and causes the CPU to execute commands included in the management program 81. Accordingly, the management server 1 operates as a computer that includes an acceptance unit 111, a setting unit 112, a release unit 113, and a notification unit 114, as software modules.

The acceptance unit 111 is configured to directly or indirectly receive a linking demand, from at least one of the first terminal 4 as the individual concerned among the first targets VA, and the second terminal 5 as the individual concerned among the second targets WA, in response to occurrence of the use relation between the individual concerned among the first targets VA and the individual concerned among the second targets WA. The acceptance unit 111 is configured to accept setting of the correspondence relation between the individual concerned among the first targets VA and the individual concerned among the second targets WA, in response to receipt of the linking demand.

The setting unit 112 is configured to execute a process for setting the accepted correspondence relation. The setting process includes setting the correspondence relation between the individual concerned among the first targets VA and the individual concerned among the second targets WA designated by the linking demand. Upon acceptance of the setting of the second correspondence relation between the first first target VA1 and the second second target WA2 different from the first second target WA1 during establishment of the setting of the first correspondence relation between the first first target VA1 and the first second target WA1, a linking setting collision occurs. The setting unit 112 is configured (I) to release the first correspondence relation, and to establish setting of the second correspondence relation, or (II) not to permit setting the second correspondence relation, and to maintain the first correspondence relation, according to a predetermined rule, in this case. The release unit 113 is configured to execute the process for releasing the correspondence relation in response to receipt of the release demand issued from at least one of the first terminal 4 and the second terminal 5, or fulfilment of the predetermined release condition.

The notification unit 114 is configured to transmit a notification indicating the result of execution of the process for setting the correspondence relation to at least one of the first terminal 4 and the second terminal 5. The notification unit 114 is configured to transmit a notification indicating the result of execution of the process for releasing the correspondence relation to at least one of the first terminal 4 and the second terminal 5.

### (First Terminal)

The controller 41 of the first terminal 4 causes the CPU to execute commands included in the program 84. Accordingly, the first terminal 4 operates as a computer that includes a data exchange unit 411, a setting request unit 412, and a unit 413, as software modules. The data exchange unit 411 is configured to execute data exchange with the second terminal 5. The setting request unit 412 is configured to transmit the linking demand (a request for linking setting) to the management server 1. The release request unit 413 is configured to transmit a release demand (a request for releasing the linking) to the management server 1.

### (Second Terminal)

The controller 51 of the second terminal 5 causes the CPU to execute commands included in the program 85. Accordingly, the second terminal 5 operates as a computer that includes a data exchange unit 511, a setting request unit 512, and a release request unit 513, as software modules. The data exchange unit 511 is configured to execute data exchange with the first terminal 4. The setting request unit 512 is configured to transmit the linking demand (a request for linking setting) to the management server 1. The release request unit 513 is configured to transmit a release demand (a request for releasing the linking) to the management server 1.

### (Other)

In the present embodiment, the example where all the software modules of each apparatus are achieved by general-purpose CPUs is described. However, some or all of the software modules may be achieved one or more dedicated processors. Each module described above may be achieved as a hardware module. As for the software configuration of each apparatus, modules may be appropriately omitted, replaced, and added depending on an embodiment. For example, in a case of adopting a form of transmitting the linking demand from only one terminal between the first terminal 4 and the second terminal 5, the setting request unit may be omitted from the other terminal. Likewise, in a case of adopting a form of transmitting the release demand from only one terminal between the first terminal 4 and the second terminal 5, the release request unit may be omitted from the other terminal.

### [3 Operation Example]

### (Linking Setting)

FIG. 12 schematically illustrates an example of a processing procedure of linking setting by the system 100 according to the present embodiment. The following processing procedure is an example of the information processing method executed by the computer. The processing procedure of the management server 1 in the following processing procedure is an example of the management method executed by the computer.

In step S10, in response to occurrence of the use relation between the first target VA and the second target WA, at least corresponding one of the controller 41 of the first terminal 4 and the controller 51 of the second terminal 5 transmits a linking demand to the management server 1. For example, in response to occurrence of the use relation, the controller 41 of the corresponding first terminal 4 may operate as the data exchange unit 411, and execute data exchange with the corresponding second terminal 5. The controller 51 of the second terminal 5 may operate as the data exchange unit 511, and execute data exchange with the first terminal 4. With this data exchange being regarded as a trigger, the controller 41 of the first terminal 4 may operate as the setting request unit 412, and transmit the linking demand to the management server 1. The controller 51 of the second terminal 5 may operate as the setting request unit 512, and transmit the linking demand to the management server 1. The linking demand may be transmitted directly to the management server 1, and transmitted indirectly via the external computer (the first server 2, the second server 3, etc.).

In step S20, the controller 11 of the management server 1 operates as the acceptance unit 111, and directly or indirectly receives the linking demand from at least one of the first terminal 4 of the individual concerned among the first targets VA and the second terminal 5 of the individual concerned among the second targets WA. The controller 11 accepts setting of the correspondence relation between the individual concerned among the first targets VA and the individual concerned among the second targets WA, in response to receipt of the linking demand.

Note that in step S10, in a case of adopting a form of transmitting a linking demand from both the first terminal 4 and the second terminal 5, one linking demand from the first terminal 4 and the second terminal 5 may be transmitted in a divided manner, or the identical linking demand may be transmitted. In the case of transmission in the divided manner, part of data of the linking demand may be transmitted from the first terminal 4, and the remaining part of data may be transmitted from the second terminal 5. In step S20, to identify the combination of the individuals concerned among the first targets VA and the second targets WA that are currently requesting setting of the correspondence relation, the management server 1 may appropriately identify the association of data (i.e., the corresponding data combination is determined).

The association of data may be identified by any method. For example, data transmitted from each of the terminals (4 and 5) may include shared information for identifying the association of data. The shared information may include, for example, information having a relation, such as matching, or fulfilment of the correspondence relation. In accordance with establishment of the relation between the shared information included in the data received from one of the first terminal 4 and the second terminal 5, and the shared information included in the data received from the other, the management server 1 may identify the association of data.

The shared information may have any configuration. For example, the shared information may include a combination of the first identifier I10 and the second identifier I20. Based on matching between the combination of the identifiers (I10 and I20) included in the data received from the first terminal 4, and the combination of the identifiers (I10 and I20) included in the data received from the second terminal 5, the management server 1 may identify the association of data. In another example, the shared information may include temporary information, such as a random number, a timestamp, or a hash value. In this case, based on establishment of the relation between the temporary information included in the data received from the first terminal 4, and the temporary information included in the data received from the second terminal 5, the management server 1 may identify the association of data. Note that the shared information may be shared between the first terminal 4 and the second terminal 5 at any timing. In a typical example, the first terminal 4 and the second terminal 5 may share the shared information when data is exchanged.

In step S25, the controller 11 of the management server 1 operates as the setting unit 112, and determines whether two or more correspondence relation settings of two or more individuals different from each other among the second targets WA with the identical individual among the first targets VA are established or not (a collision occurs or not), as a result of the process in step S20. That is, the controller 11 determines whether or not the process in step S20 corresponds to acceptance of setting of the second correspondence relation between the first first target VA1 and the second second target WA2 different from the first second target WA1 during establishment of the first correspondence relation between the first first target VA1 and the first second target WA1. For example, the controller 11 refers to the linking information D10, thus determining whether or not the individual concerned among the first targets VA that is designated by the accepted linking demand has setting of a correspondence relation with another individual among the second targets WA. The other individual corresponds to the first second target WA1, and the correspondence relation with the other individual corresponds to the first correspondence relation. If there is no correspondence relation with another individual among the second targets WA, the controller 11 proceeds the processing to step S301. On the other hand, if there is a correspondence relation with another individual among the second targets WA, the controller 11 proceeds the processing to step S302.

In step S301, the controller 11 operates as the setting unit 112, and updates the linking information D10 so as to establish the setting of the correspondence relation between the individuals concerned among the first targets VA and the second targets WA designated by the linking demand. For example, updating the linking information D10 in response to setting of the correspondence relation may include generation of new linking information D10 indicating the designated correspondence relation. After the linking information D10 is updated, the controller 11 proceeds the processing to the next step S40.

On the other hand, in step S302, the controller 11 operates as the setting unit 112 and updates the linking information D10 so as (I) to release the first correspondence relation, and to establish setting of the second correspondence relation, or discards the linking demand so as (II) not to permit setting the second correspondence relation, and to maintain the first correspondence relation, according to a predetermined rule. In an example of the present embodiment, at least any of the three rules may be adopted as the predetermined rule. The process of updating the linking information D10 upon release is described later. After the linking information D10 is updated, the controller 11 proceeds the processing to the next step S40. Note that the processes in steps S301 and S302 are examples of the process for setting the correspondence relation in response to the accepted linking demand (step S30 described above).

In step S40, the controller 11 operates as the notification unit 114, and directly or indirectly transmits a notification indicating the result of execution of the process for setting the correspondence relation to at least one of the first terminal 4 and the second terminal 5. After completion of the notification about the result, the processing procedure related to the linking setting according to this operation example is finished.

Note that the processing procedure described above is only an example. Each step may be changed as much as possible. In the processing procedure described above, steps may be appropriately omitted, replaced, and added depending on an embodiment. For example, the process of linking setting may include authentication processing for at least one of the first target VA and the second target WA.

### (Linking Release)

FIG. 13 schematically illustrates an example of a processing procedure of linking release by the system 100 according to the present embodiment. The following processing procedure is an example of the information processing method executed by the computer. The processing procedure of the management server 1 in the following processing procedure is an example of the management method executed by the computer. Note that the example in FIG. 13 assumes a situation of adopting a form of directly transmitting the release demand from the first terminal 4 to the management server 1.

In step SZ10, the controller 41 of the first terminal 4 operates as the release request unit 413, and transmits a release demand for the correspondence relation to the management server 1. In response to this, the controller 11 of the management server 1 receives the release demand. The correspondence relation for which release is requested may be appropriately designated. The trigger of the release demand may be appropriately selected depending on an embodiment.

In step SZ20, the controller 11 operates as the release unit 113, and updates the linking information D10 so as to release the setting of the correspondence relation designated by the received release demand. For example, updating the linking information D10 in response to release of the correspondence relation may include recording information indicating the release. For example, in the case where the linking information D10 has the configuration in FIG. 3A, the controller 11 may release the target correspondence relation by setting a flag for adding the release time or for release in the corresponding linking information D10. In a case where the linking information D10 is constructed in a blockchain base, the controller 11 may release the correspondence relation of targets by generating a transaction indicating the linking release, and adding the generated transaction to the blockchain.

In step SZ30, the controller 11 operates as the notification unit 114, and transmits the execution result of the linking release process to the first terminal 4. After completion of the notification about the result, the processing procedure related to the linking release according to this operation example is finished.

Note that the processing procedure described above is only an example. Each step may be changed as much as possible. In the processing procedure described above, steps may be appropriately omitted, replaced, and added depending on an embodiment. For example, as described above, the transmission route for the release demand is not necessarily limited to the example in FIG. 13, and may be appropriately selected depending on an embodiment. The release demand may be transmitted from the second terminal 5 (release request unit 513). The release demanding process may include authentication processing for at least one of the first target VA and the second target WA. The controller 11 of the management server 1 may operate as the release unit 113 instead of step SZ20 described above, and release the correspondence relation in response to fulfilment of the predetermined release condition.

### [Characteristics]

In the present embodiment, by the process in step S30 (steps S301 and S302), information indicating the setting of the correspondence relation between the individuals concerned among the first targets VA and the second targets WA is recorded. According to the record, the use relation between the individuals concerned among the first targets VA and the second targets WA can be tracked. In the present embodiment, in case a linking setting collision for one individual among the first targets VA with multiple individuals among the second targets WA occurs, the collision is settled by the processes in steps S25 and S302. Consequently, according to the present embodiment, the correspondence relation between the first target VA and the second target WA can be appropriately tracked.

### [4 Modification Example]

The embodiments of the present disclosure have thus been described in detail. However, the above description is only examples of the present disclosure in all respects. It is a matter of course that various improvements or modifications can be made without departing from the scope of the present disclosure. For example, the following change can be made. Note that hereinafter, similar symbols are used for configuration elements similar to those in the embodiment described above, and description of points similar to those in the embodiment described above is omitted. The following modification examples can be appropriately combined.

<4.1>

In the embodiment described above, in at least any of the linking setting and the linking release, the authentication processing for the first target VA and the second target WA may be executed. The authentication processing may be executed in at least any of the external servers (the first server 2, the second server 3, etc.), and the terminals (4 and 5). For example, at least any of the following four authentication methods may be adopted.

### (A) First Authentication Method

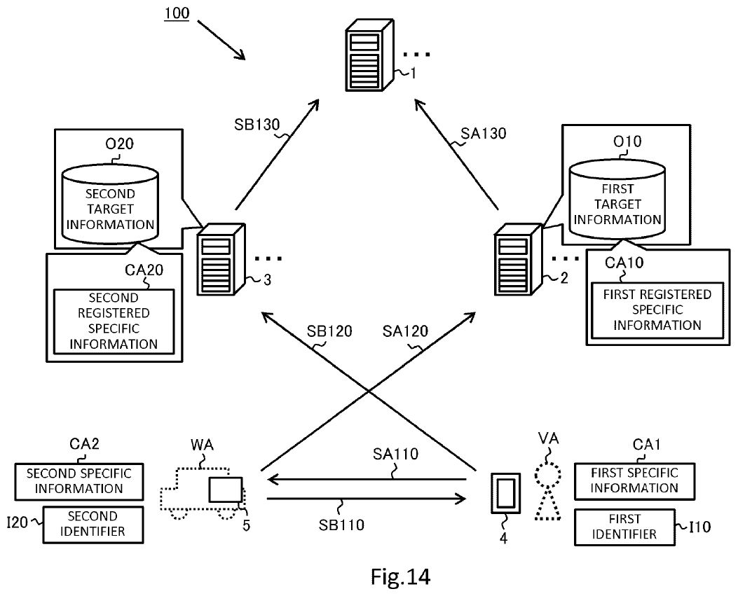

FIG. 14 schematically illustrates an example of a processing procedure of linking setting in a case of adopting a first authentication method. According to the first authentication method, in response to a request issued by the first terminal 4 of the first target VA, the second server 3 executes authentication of the second target WA, and in response to a request issued by the second terminal 5 of the second target WA, the first server 2 executes authentication of the first target VA. The terminals (4 and 5) request mutual authentication from the servers (2 and 3), and cause the management server 1 to report an authentication result. Accordingly, the terminals (4 and 5) transmit a linking demand to the management server 1.

The first server 2 is configured to be capable of accessing a first storage device that stores first registered specific information CA10 for authenticating the first target VA. The first storage device may include at least any of the memory resource of the first server 2, and the external storage device (NAS etc.). The first registered specific information CA10 may be included in the first target information O10. The second server 3 is configured to be capable of accessing a second storage device that stores second registered specific information CA20 for authenticating the second target WA. The second storage device may include at least any of the memory resource of the second server 3, and the external storage device (NAS etc.). The second registered specific information CA20 may be included in the second target information O20.

The pieces of registered specific information (CA10 and CA20) are specific information preliminarily registered for authenticating the respective targets (VA and WA). The data format and configuration of the specific information are not necessarily specifically limited only if it can be used for authentication, and may be appropriately selected depending on an embodiment. For example, the specific information may include any information, such as information derived from the targets, information derived from the terminals, temporarily generated information, or information generated by another freely selected method.

The information derived from the targets may be, for example, biometric information, uniquely assigned identification information, etc. The biometric information may be, for example, a facial image, a fingerprint, a voiceprint, etc. The uniquely assigned identification information may be, for example, a vehicle registration number, a vehicle identification number, a personal number, etc. In a case where the target is assigned an IC tag, the uniquely assigned identification information may include information held in the IC tag. The information derived from the terminals may be, for example, a MAC address, terminal identification information, etc. The temporarily generated information may be, for example, a one-time password, a private address (dynamically generated address), etc. The temporarily generated information may include a timestamp, a random number, a hash value, etc. The information generated by another freely selected method may include, for example, a password, passcode, as well as information other than symbol strings.

First, when the use relation occurs between the individuals concerned among the first targets VA and the second targets WA, data exchange is executed between the corresponding first terminal 4 and second terminal 5 (steps SA110 and SB110).

In step SA110, the second terminal 5 obtains the first identifier I10 and first specific information CA1 from the individual concerned among the first targets VA. The first specific information CA1 corresponds to the first registered specific information CA10. In data exchange, the second terminal 5 may appropriately obtain the first identifier I10 and the first specific information CA1 from the first target VA. The obtainment from the first target VA may include obtainment from the first terminal 4. For example, the second terminal 5 may obtain at least one of the first identifier I10 and the first specific information CA1 from the first target VA via the input device, the sensor, etc. In data exchange, the second terminal 5 may obtain at least one of the first identifier I10 and the first specific information CA1 from the first terminal 4.

In step SB110, the first terminal 4 obtains the second identifier I20 and second specific information CA2 from the individual concerned among the second targets WA. The second specific information CA2 corresponds to the second registered specific information CA20. In data exchange, the first terminal 4 may obtain the second identifier I20 and the second specific information CA2 from the second target WA as required. The obtainment from the second target WA may include obtainment from the second terminal 5. For example, the first terminal 4 may obtain at least one of the second identifier I20 and the second specific information CA2 from the second target WA via the input device, the sensor, etc. In data exchange, the first terminal 4 may obtain at least one of the second identifier I20 and the second specific information CA2 from the second terminal 5.

In step SA120, the second terminal 5 transmits a first authentication request that includes the first identifier I10 and the first specific information CA1 to the first server 2. In response to this, the first server 2 receives the first authentication request for the individual concerned among the first targets VA. In response to receipt of the first authentication request, the first server 2 appropriately executes an authentication processing for the first target VA. For example, the first server 2 may extract the first registered specific information CA10 on the individual concerned among the first targets VA from the first target information O10, by searching the first target information O10 using, as a query, the first identifier I10 included in the first authentication request. The first server 2 may match the extracted first registered specific information CA10 against the first specific information CA1 included in the first authentication request. The matching may be appropriately performed depending on the specific information to be used. The first server 2 may determine success or failure of authentication for the individual concerned among the first targets VA, according to the matching result. In step SA130, the first server 2 reports the authentication result for the individual concerned among the first targets VA, to the management server 1. For example, the first server 2 may assign the first identifier I10 of the first target VA to the authentication result of the first target VA, and transmit it to the management server 1. The first server 2 may transmit the authentication result to the management server 1 irrespective of success or failure of authentication, or transmit the authentication result to the management server 1 only if the authentication is achieved.

On the other hand, in step SB120, the first terminal 4 transmits a second authentication request that includes the second identifier I20 and the second specific information CA2 to the second server 3. In response to this, the second server 3 receives the second authentication request for the individual concerned among the second targets WA. In response to receipt of the second authentication request, the second server 3 appropriately executes an authentication processing for the second target WA. For example, the second server 3 may extract the second registered specific information CA20 on the individual concerned among the second targets WA from the second target information O20, by searching the second target information O20 using, as a query, the second identifier I20 included in the second authentication request. The second server 3 may match the extracted second registered specific information CA20 against the second specific information CA2 included in the second authentication request. The matching may be appropriately performed depending on the specific information to be used. The second server 3 may determine success or failure of authentication for the individual concerned among the second targets WA, according to the matching result. In step SB130, the second server 3 reports the authentication result for the individual concerned among the second targets WA, to the management server 1. For example, the second server 3 may assign the second identifier I20 of the second target WA to the authentication result of the second target WA, and transmit it to the management server 1. The second server 3 may transmit the authentication result to the management server 1 irrespective of success or failure of authentication, or transmit the authentication result to the management server 1 only if the authentication is achieved.

The second terminal 5 providing the first authentication request for the first server 2, and causing the first server 2 to transmit the authentication result to the management server 1 is an example of transmission of the linking demand by the second terminal 5 to the management server 1. The first terminal 4 providing the second authentication request for the second server 3, and causing the second server 3 to transmit the authentication result to the management server 1 is an example of transmission of the linking demand by the first terminal 4 to the management server 1. That is, in a case of adopting the first authentication method in linking setting, each of processes in steps SA120, SA130, SB120, and SB130 is an example of the process in step S10 described above.

The management server 1 receives the authentication result about the individuals concerned among the targets (VA and WA) from the servers (2 and 3). To identify the combination of the individuals concerned among the first targets VA and the second targets WA that are currently requesting setting of the correspondence relation, the management server 1 may identify the association of data of the authentication result by a method of using the shared information or the like. If both the authentication of the first target VA and that of the second target WA are achieved in the received authentication results of the first target VA and the second target WA, the management server 1 sets the correspondence relation between the individuals concerned among the first targets VA and the second targets WA. The process for setting the correspondence relation may be similar to that in the embodiment described above. A series of processes from the data exchange between the terminals (4 and 5) to linking setting may be executed in real time upon occurrence of the use relation.

According to the first authentication method, in response to occurrence of the use relation between the individuals concerned among the first targets VA and the second targets WA, authentication of the individuals concerned among the first targets VA and the second targets WA is performed in the first server 2 and the second server 3. At this time, authentication of the first target VA is requested by the second terminal 5 of the second target WA. Authentication of the second target WA is requested by the first terminal 4 of the first target VA. That is, without proceeding of their own authentication, cross-authentication that proceeds authentication of the other party is performed. It is thus expected to ensure security.

Note that the processing procedure in FIG. 14 is only an example. Each step may be changed as much as possible. In the processing procedure described above, steps may be appropriately omitted, replaced, and added depending on an embodiment. For example, the processing order of steps SA110 to SA130 and steps SB110 to SB130 is not necessarily specifically limited, and may be appropriately determined depending on an embodiment. At least one of the authentication processing for the first target VA (steps SA110 to SA130) and the authentication processing for the second target WA (steps SB110 to SB130) may be omitted.

### (B) Second Authentication Method

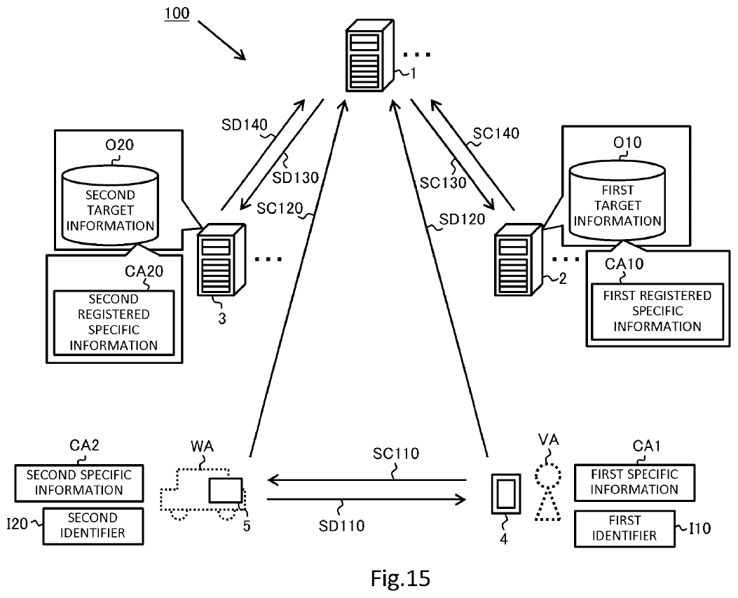

FIG. 15 schematically illustrates an example of the processing procedure of linking setting in a case of adopting a second authentication method. According to the second authentication method, in response to a request by at least one of the first terminal 4 and the second terminal 5, the management server 1 requests authentication from the servers (2 and 3). That is, at least one of the first terminal 4 and the second terminal 5 transmits the linking demand that includes the authentication request for each target (VA, WA). Data (specific information) used for authentication is similar to that in the first authentication method.

First, when the use relation occurs between the individuals concerned among the first targets VA and the second targets WA, data exchange is executed between the corresponding first terminal 4 and second terminal 5 (steps SC110 and SD110). At least one of the first terminal 4 and the second terminal 5 transmits, as a linking demand, an authentication request that includes the first identifier I10, the first specific information CA1, the second identifier I20, and the second specific information CA2, to the management server 1 (steps SC120 and SD120). In response to this, the management server 1 receives the authentication request that includes the first identifier I10, the first specific information CA1, the second identifier I20, and the second specific information CA2. Each of the processes in steps SC120 and SD120 is an example of the process in step S10 described above.

Division of the data transmission may be appropriately determined depending on an embodiment. For example, transmission of the first identifier I10 and the first specific information CA1 may be handled by the second terminal 5, and transmission of the second identifier I20 and the second specific information CA2 may be handled by the first terminal 4. That is, in step SC110, the second terminal 5 may obtain the first identifier I10 and the first specific information CA1 from the first target VA. The obtainment from the first target VA may include obtainment from the first terminal 4. In step SC120, the second terminal 5 may transmit the linking demand that includes the obtained first identifier I10 and first specific information CA1 to the management server 1. In step SD110, the first terminal 4 may obtain the second identifier I20 and the second specific information CA2 from the second target WA. The obtainment from the second target WA may include obtainment from the second terminal 5. In step SD120, the first terminal 4 may transmit the linking demand that includes the obtained second identifier I20 and second specific information CA2 to the management server 1.

Division of the data transmission is not necessarily limited to such an example. In another example, at least one of the first identifier I10 and the first specific information CA1 may be transmitted from the first terminal 4. At least one of the second identifier I20 and the second specific information CA2 may be transmitted from the second terminal 5. In the case of adopting the form of transmission in a divided manner, to identify the combination of the individuals concerned among the first targets VA and the second targets WA that are currently requesting setting of the correspondence relation, the management server 1 may identify the association of data of the authentication request by a method of using the shared information or the like. In still another example, the first identifier I10, the first specific information CA1, the second identifier I20, and the second specific information CA2 may be transmitted from only one of the first terminal 4 and the second terminal 5.

In step SC130, the management server 1 transmits the first identifier I10 and the first specific information CA1 in the received data to the first server 2, thus requesting the first server 2 to authenticate the individual concerned among the first targets VA. In response to this, the first server 2 may match the first specific information CA1, and the first registered specific information CA10, and may determine success or failure of authentication of the individual concerned among the first targets VA in accordance with the matching result. In step SC140, the first server 2 returns the authentication result for the individual concerned among the first targets VA, to the management server 1.

Likewise, in step SD130, the management server 1 transmits the second identifier I20 and the second specific information CA2 to the second server 3, thus requesting the second server 3 to authenticate the individual concerned among the second targets WA. In response to this, the second server 3 may match the second specific information CA2 and the second registered specific information CA20, and may determine success or failure of authentication of the individual concerned among the second targets WA in accordance with the matching result. In step SD140, the second server 3 transmits the authentication result for the individual concerned among the second targets WA, to the management server 1.

The management server 1 receives the authentication result about the individuals concerned among the targets (VA and WA) from the servers (2 and 3). If both the authentication of the first target VA and that of the second target WA are achieved in the received authentication results of the first target VA and the second target WA, the management server 1 sets the correspondence relation between the individuals concerned among the first targets VA and the second targets WA. The process for setting the correspondence relation may be similar to that in the embodiment described above. A series of processes from the data exchange between the terminals (4 and 5) to linking setting may be executed in real time upon occurrence of the use relation. The other configurational points may be similar to those in the first authentication method.

According to the second authentication method, in response to occurrence of the use relation between the individuals concerned among the first targets VA and the second targets WA, authentication of the individuals concerned among the first targets VA and the second targets WA is performed in the first server 2 and the second server 3, respectively. According to the two types of authentication, it is expected to ensure security.

Note that the processing procedure in FIG. 15 is only an example. Each step may be changed as much as possible. In the processing procedure described above, steps may be appropriately omitted, replaced, and added depending on an embodiment. For example, the processing order of steps SC110 to SC140 and steps SD110 to SD140 is not necessarily specifically limited, and may be appropriately determined depending on an embodiment. The authentication processing of at least one of the first target VA (steps SC110 to SC140) and the authentication processing for the second target WA (steps SD110 to SD140) may be omitted.

### (C-1) 3-1-Th Authentication Method

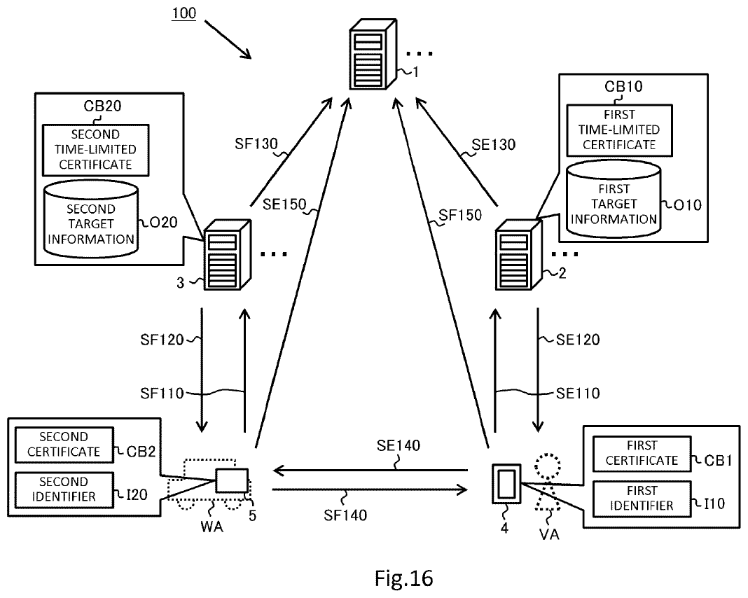

FIG. 16 schematically illustrates an example of the processing procedure of linking setting in a case of adopting a 3-1-th authentication method. The 3-1-th authentication method uses a time-limited certificate for authentication, instead of the specific information. The authentication processing is executed by the management server 1.

The first server 2 is configured to issue a first time-limited certificate CB10 to each of individuals of the first targets VA. The second server 3 is configured to issue a second time-limited certificate CB20 to each of individuals of the second targets WA.

Each of the time-limited certificates (CB10 and CB20) is configured to expire after lapse of an effective period. Only if expiration due to the lapse of the effective period can be controlled, the configuration of each of the time-limited certificates (CB10 and CB20) is not necessarily specifically limited, and may be appropriately selected depending on the embodiment. Each of the time-limited certificates (CB10 and CB20) may include any information. For example, each of the time-limited certificates (CB10 and CB20) may include a random number, a timestamp, a hash value, or the like. Each of the time-limited certificates (CB10 and CB20) may include temporary information, such as a one-time password.

The effective periods of the time-limited certificates (CB10 and CB20) may be appropriately managed. The expiration due to the lapse of the effective period may be appropriately identified. For example, it may be identified whether the target time-limited certificate has expired or not, depending on expiration of a period set in the time-limited certificate, the time-limited certificate being added in an expiration list, the time-limited certificate being removed from an effective list, update to a new time-limited certificate, addition of information indicating expiration (e.g., a timestamp) or the like. In the case of using reference information, such as the expiration list or the effective list, for managing the effective period, the reference information may be stored in any storage device accessible from the system 100. Typically, the reference information on the time-limited certificate (CB10, CB20) may be stored in the corresponding server (2, 3).

First, in step SE110, with respect to the first identifier I10 of the first target VA, the first terminal 4 of the first target VA transmits, to the first server 2, a request for issuing the first time-limited certificate CB10. In response to receipt of the request, the first server 2 issues the first time-limited certificate CB10, with respect to the first identifier I10. In step SE120, the first server 2 returns the issued first time-limited certificate CB10 to the first terminal 4. In response to this, the first terminal 4 receives the issued first time-limited certificate CB10 from the first server 2. The first terminal 4 stores the received first time-limited certificate CB10 so as to be usable as a first certificate CB1. In step SE130, the first server 2 also notifies the management server 1 of the issued first time-limited certificate CB10. The first server 2 may add the first identifier I10 to the first time-limited certificate CB10, and issue the notification thereabout.

In step SF110, with respect to the second identifier I20 of the second target WA, the second terminal 5 of the second target WA transmits, to the second server 3, a request for issuing the second time-limited certificate CB20. In response to receipt of the request, the second server 3 issues the second time-limited certificate CB20, with respect to the second identifier I20. In step SF120, the second server 3 returns the issued second time-limited certificate CB20 to the second terminal 5. In response to this, the second terminal 5 receives the issued second time-limited certificate CB20 from the second server 3. The second terminal 5 stores the received second time-limited certificate CB20 so as to be usable as a second certificate CB2. In step SF130, the second server 3 also notifies the management server 1 of the issued second time-limited certificate CB20. The second server 3 may add the second identifier I20 to the second time-limited certificate CB20, and issue the notification thereabout.

When the use relation occurs between the individuals concerned among the first targets VA and the second targets WA, data exchange is executed between the corresponding first terminal 4 and second terminal 5 (steps SE140 and SF140). At least one of the first terminal 4 and the second terminal 5 transmits an authentication request that includes the first certificate CB1 and the second certificate CB2, as a linking demand, to the management server 1 (steps SE150 and SF150). In response to this, the management server 1 receives the first certificate CB1 corresponding to the first time-limited certificate CB10, and the second certificate CB2 corresponding to the second time-limited certificate CB20. Each of the processes in steps SE150 and SF150 is an example of the process in step S10 described above.

Division of the data transmission may be appropriately determined depending on the embodiment. For example, transmission of the first certificate CB1 may be handled by the second terminal 5, and transmission of the second certificate CB2 may be handled by the first terminal 4. That is, in step SE140, the second terminal 5 may obtain the first certificate CB1 from the first terminal 4. In step SE150, the second terminal 5 may transmit the linking demand that includes the first certificate CB1 to the management server 1. In step SF140, the first terminal 4 may obtain the second certificate CB2 from the second terminal 5. In step SF150, the first terminal 4 may transmit the linking demand that includes the second certificate CB2 to the management server 1.

Division of the data transmission is not necessarily limited to such an example. In another example, the first certificate CB1 may be transmitted from the first terminal 4. The second certificate CB2 may be transmitted from the second terminal 5. With the certificates (CB1 and CB2), the identifiers (I10 and I20) may also be transmitted to the management server 1. Each of the identifiers (I10 and I20) may be transmitted from at least one of the first terminal 4 and the second terminal 5. In the case of adopting the form of transmission in a divided manner, to identify the combination of the individuals concerned among the first targets VA and the second targets WA that are currently requesting setting of the correspondence relation, the management server 1 may identify the association of data of the authentication request by a method of using the shared information or the like. In still another example, the first certificate CB1 and the second certificate CB2 may be transmitted from only one of the first terminal 4 and the second terminal 5.

The management server 1 matches the received first certificate CB1 against the first time-limited certificate CB10 notified from the first server 2. The management server 1 matches the received second certificate CB2 against the second time-limited certificate CB20 notified from the second server 3. The management server 1 may appropriately identify the association of data to be matched. Identification of the association of data to be matched means determination of the combination of the first time-limited certificate CB10 and the first certificate CB1, which are matched, and the combination of the second time-limited certificate CB20 and the second certificate CB2, which are matched. Similar to the association of data in the authentication request, the management server 1 may identify the association of data to be matched, through a method of using the shared information described above. The shared information may be the identifiers (I10 and I20).

The method of matching the certificate and the time-limited certificate may be appropriately selected depending on the relation between both the items. For example, the time-limited certificates (CB10 and CB20) may be used as the certificates (CB1 and CB2) as they are. In this case, success or failure of the matching in authentication may be determined according to whether the time-limited certificates (CB10 and CB20) and the certificates (CB1 and CB2) match each other or not. In another example, the time-limited certificates (CB10 and CB20) may be arbitrarily converted, and the converted time-limited certificates (CB10 and CB20) may be used as the certificates (CB1 and CB2). In this case, success or failure of the matching in authentication may be determined according to whether a predetermined relation is satisfied between the time-limited certificates (CB10 and CB20) and the certificates (CB1 and CB2) or not. For example, the first time-limited certificate CB10 may be converted into a hash value, and the obtained hash value may be used as the first certificate CB1. In response to this, it is determined whether the relation is achieved or not according to whether the hash value of the first time-limited certificate CB10 matches the first certificate CB1 or not. The conversion may include data operation, such as deletion and addition. At least one of the first time-limited certificate CB10 and the second time-limited certificate CB20 may be used as the certificate as it is, and the other may be converted and then be used as the certificate. Note that the conversion process may be executed in the terminals (4 and 5), or be executed in the servers (2 and 3). In the case where the conversion process is executed in the servers (2 and 3), the terminals (4 and 5) may receive the converted time-limited certificates (CB10 and CB20) from the servers (2 and 3).

The management server 1 may determine success or failure of authentication for the individuals concerned among the targets (VA and WA), according to the matching result. If the matching fails, the authentication is not achieved. If the first time-limited certificate CB10/second time-limited certificate CB20 expires due to expiration of the effective period, matching of the first target VA/second targets WA is not achieved. On the other hand, if the first time-limited certificate CB10 and the second time-limited certificate CB20 are effective, and the matching thereof is achieved, both the authentication of the first target VA and that of the second target WA are achieved. If both the authentication of the first target VA and that of the second target WA are achieved, the management server 1 sets the correspondence relation between the individuals concerned among the first targets VA and the second targets WA. The process for setting the correspondence relation may be similar to that in the embodiment described above. A series of processes from the data exchange between the terminals (4 and 5) to linking setting may be executed in real time upon occurrence of the use relation. The other configurational points may be similar to those in the first authentication method and the like.

According to the 3-1-th method, in response to occurrence of the use relation between the individuals concerned among the first targets VA and the second targets WA, authentication of each of the first target VA and the second target WA is performed using the time-limited certificates (CB10 and CB20). Each of the time-limited certificates (CB10 and CB20) is configured to expire after lapse of the effective period. Accordingly, permanent use of the same certificate can be prevented. It is thus expected to ensure security.

Note that the processing procedure in FIG. 16 is only an example. Each step may be changed as much as possible. In the processing procedure described above, steps may be appropriately omitted, replaced, and added depending on an embodiment. For example, the processing order of steps SE110 to SE150 and steps SF110 to SF150 is not necessarily specifically limited, and may be appropriately determined depending on an embodiment. At least one of the authentication processing for the first target VA (steps SE110 to SE150) and the authentication processing for the second target WA (steps SF110 to SF150) may be omitted.

Issuance of the time-limited certificates (CB10 and CB20) is not necessarily based on requests (demands) from the terminals (4 and 5). The servers (2 and 3) may autonomously generate the time-limited certificates (CB10 and CB20). In this case, the processes in steps SE110 and SF110 can be omitted.

The issuance of the time-limited certificates (CB10 and CB20) (steps SE110 to SE130 and steps SF110 to SF130) may be executed at any timing before the request for linking setting (steps SE150 and SF150). For example, the issuance of the time-limited certificates (CB10 and CB20) may be preliminarily executed before execution of data exchange between the first terminal 4 and the second terminal 5 (steps SE140 and SF140). In another example, it may be executed at timing after the data exchange between the first terminal 4 and the second terminal 5 is started or before the linking demand is transmitted. In view of reducing the number of steps for linking setting, it is preferable that the issuance of the time-limited certificates (CB10 and CB20) be executed at the timing of the former.

According to the 3-1-th authentication method described above, the matching processes between the certificates (CB1 and CB2) and the time-limited certificates (CB10 and CB20), i.e., the authentication processing of each target (VA, WA) is executed by the management server 1. However, the subject entity that executes the matching process is not necessarily limited to the management server 1. In another example, the management server 1 may transmit the certificates (CB1 and CB2) to the servers (2 and 3), thus requesting the matching processes from the servers (2 and 3). Thus, the matching process may be executed by the servers (2 and 3).

(C-2) 3-2-th Authentication Method

According to the 3-1-th authentication method described above, in response to a linking demand by at least one of the first terminal 4 and the second terminal 5, the authentication processing of each target (VA, WA) may be executed. However, the timing at which the authentication processing is executed is not necessarily limited to that in such an example. According to the 3-2-th authentication method described above, before transmission of the linking demand to the management server 1, the authentication processing for at least one of the first target VA and the second target WA may be preliminarily executed by at least one of the first terminal 4 and the second terminal 5 with at least one of the first server 2 and the second server 3.

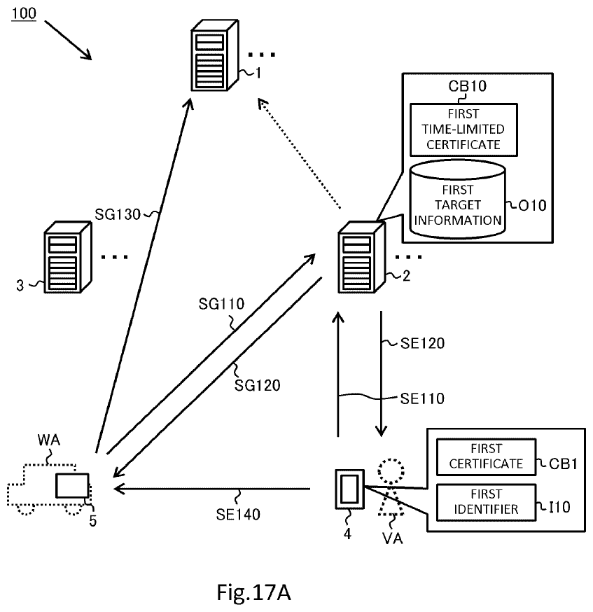

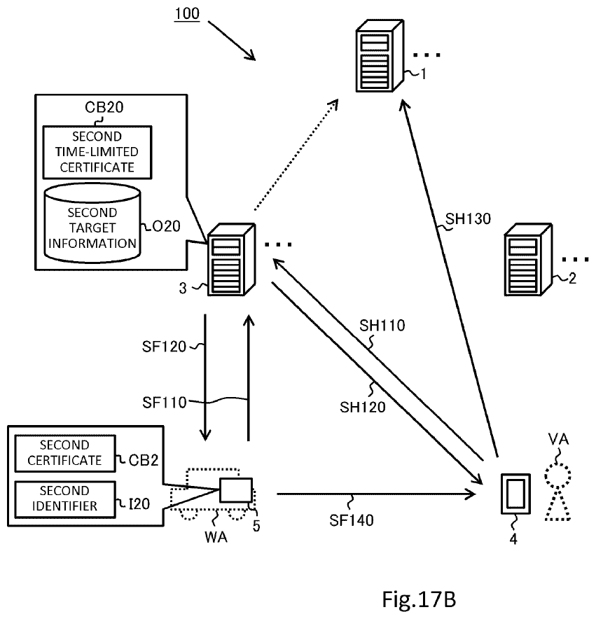

FIG. 17A schematically illustrates an example of the processing procedure of linking setting in the case of adopting the 3-2-th authentication method. In the example in FIG. 17A, a situation is assumed where the authentication processing for the first target VA is executed and the authentication processing for the second target WA is omitted.

First, between the first terminal 4 and the first server 2, the processes in steps SE110 and SE120 may be executed similarly to that in the 3-1-th authentication method described above. As a result of the execution, the first time-limited certificate CB10 is issued, and the issued first time-limited certificate CB10 is notified to the first terminal 4. At this time, the first server 2 may store the issued first time-limited certificate CB10 in association with the first identifier I10. The first time-limited certificate CB10 may be stored as the first target information O10. The notification to the management server 1 (step SE130) may be omitted. In step SE140, the first terminal 4 provides the second terminal 5 with the issued first time-limited certificate CB10 as the first certificate CB1. The first terminal 4 provides the first identifier I10 for the second terminal 5. In response to this, the second terminal 5 obtains the first identifier I10 and the first certificate CB1 from the first target VA.

In step SG110, the second terminal 5 transmits an authentication request that includes the first identifier I10 and the first certificate CB1 to the first server 2. In response to receipt of the authentication request, the first server 2 matches the received first certificate CB1 against the corresponding first time-limited certificate CB10. The corresponding first time-limited certificate CB10 may be obtained as required. For example, the issued first time-limited certificate CB10 may be stored as the first target information O10, and the first server 2 may use the first identifier I10 for a query and search the first target information O10, thus extracting the corresponding first time-limited certificate CB10. In step SG120, the first server 2 returns the matching result to the second terminal 5. In response to this, the controller 51 of the second terminal 5 receives the matching result.

If the matching between the first certificate CB1 and the first time-limited certificate CB10 is not achieved in the received matching result, the second terminal 5 may appropriately finish the processing procedure of linking setting. The second terminal 5 may request the first terminal 4 to retransmit the first certificate CB1. On the other hand, if the matching is achieved, the second terminal 5 transmits the linking demand that includes the first identifier I10 and the second identifier I20 to the management server 1 (step SG130). The process in step SG130 is an example of the process in step S10 described above.

In response to this, the management server 1 receives the linking demand from the second terminal 5. In response to the linking demand, the management server 1 sets the correspondence relation between the individuals concerned among the first targets VA and the second targets WA. The process for setting the correspondence relation may be similar to that in the embodiment described above. A series of processes from the data exchange between the terminals (4 and 5) (step SE140) to linking setting may be executed in real time upon occurrence of the use relation. The other configurational points may be similar to those in the first authentication method and the like.

Note that the processing procedure in FIG. 17A is only an example. Each step may be changed as much as possible. In the processing procedure described above, steps may be appropriately omitted, replaced, and added depending on an embodiment.

For example, the management server 1 may verify that the matching is achieved in the first server 2, as required. For example, the first server 2 may transmit the matching result also to the management server 1. For example, the authentication request described above may further include the second identifier I20. If the matching is achieved, the first server 2 may transmit the matching result that includes the first identifier I10 and the second identifier I20 to the management server 1. Accordingly, for the management server 1, the first server 2 may activate the linking demand for the combination of the first identifier I10 and the second identifier I20 designated by the matching result. That is, for example, the verification of achievement of matching may be made up of receipt of the matching result. The management server 1 may be configured to hold the matching result from the first server 2, accept the request for linking setting about the combination of the first identifier I10 and the second identifier I20 designated by the matching result, and discard another request for linking setting.

According to the 3-2-th authentication method, the authentication target is not necessarily limited to the first target VA. In another example, instead of the authentication processing for the first target VA, the authentication processing for the second target WA may be executed. In still another example, in conjunction with the authentication processing for the first target VA, the authentication processing for the second target WA may be executed.

FIG. 17B schematically illustrates another example of the processing procedure of linking setting in the case of adopting the 3-2-th authentication method. In the example in FIG. 17B, a situation is assumed where instead of the authentication processing for the first target VA, the authentication processing for the second target WA is executed. Except the replacement of the first target VA and the second target WA, the processing procedure in FIG. 17B may be similar to the processing procedure in FIG. 17A. That is, between the second terminal 5 and the second server 3, the processes in steps SF110 and SF120 are executed, which issues the second time-limited certificate CB20; the second terminal 5 is notified of the issued second time-limited certificate CB20. In step SF140, the second terminal 5 provides the first terminal 4 with the issued second time-limited certificate CB20 as the second certificate CB2. The second terminal 5 provides the second identifier I20 for the first terminal 4. In step SH110, the first terminal 4 transmits an authentication request that includes the second identifier I20 and the second certificate CB2 to the second server 3. In response to this, the second server 3 executes the matching process between the second certificate CB2 and the second time-limited certificate CB20. In step SH120, the second server 3 returns the matching result to the first terminal 4. If the matching between the second certificate CB2 and the second time-limited certificate CB20 is achieved in the received matching result, the first terminal 4 transmits the linking demand that includes the first identifier I10 and the second identifier I20 to the management server 1 (step SH130). In response to this, the management server 1 receives the linking demand from the first terminal 4. In response to the linking demand, the management server 1 sets the correspondence relation between the individuals concerned among the first targets VA and the second targets WA. In another example, the authentication processing for the first target VA and the second target WA may be executed by executing the series of processes in FIGS. 17A and 17B.

According to the 3-2-th authentication method, before the linking demand, the authentication processing is executed. Accordingly, the processing load on the management server 1 can be reduced. Furthermore, the processing time period from the linking demand to the setting process can be reduced.

### (D) Fourth Authentication Method

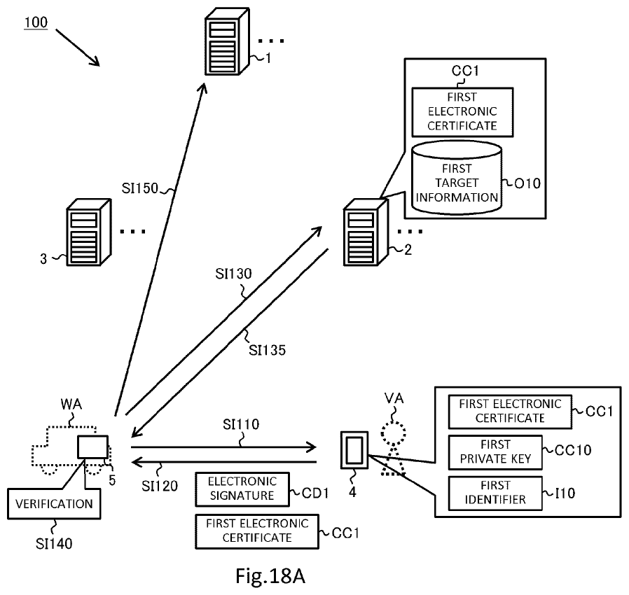

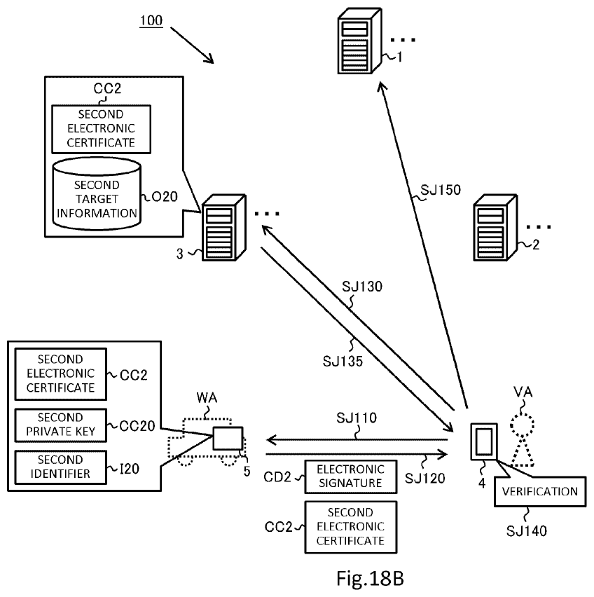

FIG. 18A schematically illustrates an example of the processing procedure of linking setting in a case of adopting a fourth authentication method. The fourth authentication method uses an electronic signature and an electronic certificate based on a private key. The authentication processing is executed by the opposite terminal of the authentication target. The opposite terminal of the authentication target is the second terminal 5 in a case of authenticating the first target VA, and is the first terminal 4 in the case of authenticating the second target WA. In the example in FIG. 18A, a situation is assumed where the authentication processing for the second target WA is omitted, and the authentication processing for the first target VA is executed.

On a preliminary stage (preprocess), the combination of a first private key CC10 and a first public key that are used to authenticate the first target VA is generated. The method of generating the first private key CC10 and the first public key is not necessarily specifically limited, and may be appropriately selected depending on an embodiment. The first private key CC10 and the first public key may be generated by at least any of the first terminal 4 and the external computer (the first server 2, a certificate authority, etc.).

Next, a first electronic certificate CC1 for the first public key is generated by the certificate authority. For example, the certificate authority may generate the first electronic certificate CC1 in response to the request by the first terminal 4. The certificate authority may be the first server 2, or an external server other than the first server 2. Only if the authenticity of the first public key can be verified, the configuration of the first electronic certificate CC1 is not necessarily specifically limited, and may be appropriately selected depending on the embodiment. For example, the first electronic certificate CC1 may include an electronic signature by the certificate authority, ownership information, and the first public key. The certificate authority stores the combination of the public key and the private key. The electronic signature by the certificate authority may be generated by encrypting the ownership information and the first public key with the private key of the certificate authority. In a specific example, the electronic signature by the certificate authority may be generated by converting the ownership information and the first public key with a hash function into a hash value, and encrypting the obtained hash value with the private key of the certificate authority.

The first electronic certificate CC1 is provided from the certificate authority for the first terminal 4. The first electronic certificate CC1 may be stored in any storage region. The expiration period of the first electronic certificate CC1 may be managed by the expiration list. The expiration list may also be stored in any storage region. The first electronic certificate CC1 and the expiration list may be stored in the first server 2, or stored in an external server accessible from the first server 2. The first terminal 4 comes into a state of holding the first private key CC10 and the first electronic certificate CC1, thus completing preparation for the authentication processing for the first target VA.

On a use stage, when the use relation occurs between the individuals concerned among the first targets VA and the second targets WA, data exchange is executed between the corresponding first terminal 4 and second terminal 5 (steps SI110 and SI120). Through this data exchange, the electronic information is shared between the first terminal 4 and the second terminal 5. The electronic information may include, for example, any information, such as a random number and a timestamp. The electronic information may include, for example, information derived from the first target VA, such as owner information on the first terminal 4.

The electronic information may be generated in at least one of the first terminal 4 and the second terminal 5. In a case where the second terminal 5 is involved in generation of at least part of the electronic information, data related to the electronic information may be provided from the second terminal 5 for the first terminal 4, in the process in step SI110. The first terminal 4 generates an electronic signature CD1 by encrypting the first identifier I10 and the electronic information using the first private key CC10. In a specific example, the first terminal 4 may convert the first identifier I10 and the electronic information into a hash value using a hash function, and generate the electronic signature CD1 by encrypting the obtained hash value with the first private key CC10.

In step SI120, the first terminal 4 provides the second terminal 5 with the first identifier I10, the generated electronic signature CD1, and the first electronic certificate CC1. Thus, the second terminal 5 obtains the first identifier I10, the electronic signature CD1, and the first electronic certificate CC1 from the first terminal 4. In a case where the first terminal 4 is involved in generation of at least part of the electronic information, such as information derived from the first target VA, data related to the electronic information may be provided from the first terminal 4 for the second terminal 5, in the process in step SI120.

Next, the second terminal 5 verifies the effectiveness of the first electronic certificate CC1 (steps SI130 and SI135). In the example in FIG. 18A, a situation where the first server 2 holds the expiration list is assumed. In step SI130, the second terminal 5 inquires of the first server 2 whether the first electronic certificate CC1 is effective or not. If the first electronic certificate CC1 is not registered in the expiration list, it is determined that the first electronic certificate CC1 is effective (i.e., the expiration period has not elapsed). If the first electronic certificate CC1 is registered in the expiration list, it is determined that the first electronic certificate CC1 is not effective. The first server 2 refers to the expiration list, and determines whether the first electronic certificate CC1 is effective or not. In step SI135, the first server 2 returns the determination result to the second terminal 5. Along therewith, the second terminals 5 may inquire of the first server 2 whether the first identifier I10 is effective or not. Note that in a case where the expiration list is held in an external server, the second terminal 5 may inquire of the external server directly or indirectly (for example, via the first server 2) whether the first electronic certificate CC1 is effective or not. In another example, the second terminal 5 may obtain the expiration list, refer to the obtained expiration list, and determine whether the first electronic certificate CC1 is effective or not. If the first electronic certificate CC1 is not effective (i.e., the expiration period has elapsed), the second terminal 5 may certify that the verification of the effectiveness of the first electronic certificate CC1 is not achieved, and appropriately finish the processing procedure of linking setting. The second terminal 5 may request the first terminal 4 to retransmit the series of pieces of information. On the other hand, if the first electronic certificate CC1 is effective, the second terminal 5 obtains the public key of the certificate authority as required. The second terminal 5 decrypts the electronic signature of the certificate authority included in the first electronic certificate CC1 using the obtained public key. The second terminal 5 matches the obtained encrypted data against the remaining information (the ownership information and the first public key) included in the first electronic certificate CC1. In a case of conversion into a hash value and subsequent encryption, the second terminal 5 converts the ownership information and the first public key into the hash value using the hash function, and matches the obtained hash value against the encrypted data. The second terminal 5 certifies that verification of the effectiveness of the first electronic certificate CC1 is achieved if both match each other in the matching, and certifies that verification of the effectiveness of the first electronic certificate CC1 is not achieved if both do not match each other.

The second terminal 5 verifies the effectiveness of the electronic signature CD1 (step SI140). The second terminal 5 decrypts the electronic signature CD1 using the first public key included in the first electronic certificate CC1. The second terminal 5 matches the obtained encrypted data against the shared information (the first identifier I10 and the electronic information). In the case of conversion into a hash value and subsequent encryption, the second terminal 5 converts the shared information (the first identifier I10 and the electronic information) into the hash value with the hash function, and matches the obtained hash value against the encrypted data. The second terminal 5 certifies that verification of the effectiveness of the electronic signature CD1 is achieved if both match each other in the matching, and certifies that verification of the effectiveness of the electronic signature CD1 is not achieved if both do not match each other.

If both the verification of the first electronic certificate CC1 and that of the electronic signature CD1 are achieved, the second terminal 5 transmits a linking demand that includes the first identifier I10 and the second identifier I20 to the management server 1 (step SI150). In response to this, the management server 1 receives the linking demand from the second terminal 5. In response to the linking demand, the management server 1 sets the correspondence relation between the individuals concerned among the first targets VA and the second targets WA. The process for setting the correspondence relation may be similar to that in the embodiment described above. A series of processes from the data exchange between the terminals (4 and 5) to linking setting may be executed in real time upon occurrence of the use relation. The process in step SI150 is an example of the process in step S10 described above. On the other hand, if at least one of the verification of the effectiveness of the first electronic certificate CC1 and that of the electronic signature CD1 is not achieved, the second terminal 5 appropriately finishes the processing procedure of linking setting. The second terminal 5 may request the first terminal 4 to retransmit the series of pieces of information.

Note that the processing procedure in FIG. 18A is only an example. Each step may be changed as much as possible. In the processing procedure described above, steps may be appropriately omitted, replaced, and added depending on an embodiment. For example, the processing order of the verification of the effectiveness of the first electronic certificate CC1 (steps SI130 and SI135) and the verification of the effectiveness of the electronic signature CD1 (step SI140) may be appropriately changed. In another example, the verification of the effectiveness of the electronic signature CD1 may be executed before the verification of the effectiveness of the first electronic certificate CC1. The process of verifying the effectiveness of the first electronic certificate CC1, and the process of verifying the effectiveness of the electronic signature CD1 may be executed at least partially in parallel.

According to the fourth authentication method, the authentication target is not necessarily limited to the first target VA. In another example, instead of the authentication processing for the first target VA, the authentication processing for the second target WA may be executed. In still another example, in conjunction with the authentication processing for the first target VA, the authentication processing for the second target WA may be executed.

FIG. 18B schematically illustrates another example of the processing procedure of linking setting in the case of adopting the fourth authentication method. In the example in FIG. 18B, a situation is assumed where instead of the authentication processing for the first target VA, the authentication processing for the second target WA is executed. Except the replacement of the first target VA and the second target WA, the processing procedure and each data item in FIG. 18B may be similar to the processing procedure and each data item in FIG. 18A. That is, on the preliminary stage, the combination of a second private key CC20 and a second public key is generated. Next, a second electronic certificate CC2 for the second public key is generated by the certificate authority. For example, the second electronic certificate CC2 may include an electronic signature by the certificate authority, ownership information, and the second public key. The second electronic certificate CC2 is provided from the certificate authority for the second terminal 5. On a use stage, when the use relation occurs between the individuals concerned among the first targets VA and the second targets WA, data exchange is executed between the corresponding first terminal 4 and second terminal 5 (steps SJ110 and SJ120). Through this data exchange, the electronic information is shared between the first terminal 4 and the second terminal 5. The second terminal 5 generates an electronic signature CD2 by encrypting the second identifier I20 and the electronic information using the second private key CC20. The second terminal 5 provides the first terminal 4 with the second identifier I20, the generated electronic signature CD2, and the second electronic certificate CC2. Thus, the first terminal 4 obtains the second identifier I20, the electronic signature CD2, and the second electronic certificate CC2. The first terminal 4 verifies the effectiveness of the second electronic certificate CC2 (steps SJ130 and SJ135). The first terminal 4 verifies the effectiveness of the electronic signature CD2 (step SJ140). If both the verification of the second electronic certificate CC2 and that of the electronic signature CD2 are achieved, the first terminal 4 transmits a linking demand that includes the first identifier I10 and the second identifier I20 to the management server 1 (step SJ150). In response to this, the management server 1 receives the linking demand from the first terminal 4. In response to the linking demand, the management server 1 sets the correspondence relation between the individuals concerned among the first targets VA and the second targets WA. The process for setting the correspondence relation may be similar to that in the embodiment described above. On the other hand, if at least one of the verification of the effectiveness of the second electronic certificate CC2 and that of the electronic signature CD2 is not achieved, the first terminal 4 appropriately finishes the processing procedure of linking setting. The first terminal 4 may request the second terminal 5 to retransmit the series of pieces of information. In another example, the authentication processing for the first target VA and the second target WA may be executed by executing the series of processes in FIGS. 18A and 18B.

According to the fourth authentication method, at least one of the first target VA and the second target WA is authenticated using the private key and the electronic certificate. It is thus expected to ensure security. By performing the authentication processing on the terminal side before the linking demand, reduction in the processing load on the management server 1 is expected. Furthermore, the processing time period from the linking demand to the setting process can be reduced.

### [5 Supplemental]

The processes and means described in the present disclosure may be freely combined and executed only if no technical contradiction occurs.

The process described to be performed by one apparatus may be shared and executed by a plurality of apparatuses. Alternatively, the processes described to be performed by different apparatuses may be executed by a single apparatus. In the computer system, it can be flexibly changed what hardware configuration achieves each function.

The present disclosure can be achieved also by providing a computer with a computer program where the functions described in the aforementioned embodiment are implemented, and causing one or more processors included in the computer to read and execute the program. Such a computer program may be provided for the computer through a non-transitory computer-readable storage medium connectable to a system bus of the computer, or provided for the computer via a network. The non-transitory computer-readable storage medium includes, for example, any type of disk/disc, such as a magnetic disk (a Floppy® disk, a hard disk drive (HDD), etc.), and an optical disc (a CD-ROM, a DVD disc, a Blu-ray Disc, etc.), a read-only memory (ROM), a random-access memory (RAM), an EPROM, an EEPROM, a magnetic card, a flash memory, an optical card, a semiconductor drive (solid-state drive etc.), any type of medium suitable for storing electronic commands, etc.

What is claimed is:

1. A system, comprising:
a server;
a first terminal;
a second terminal; and
a third terminal;
wherein the server is configured to execute if, while setting of a first correspondence relation between the first terminal and the second terminal is activating, accepting a request to activate a second correspondence relation between the first terminal and the third terminal, (I) deactivating the first correspondence relation, and activating the second correspondence relation, or (II) not permitting activating the second correspondence relation, and maintaining the activation of the first correspondence relation, according to a predetermined rule.

2. A system, comprising:
a management server;
a plurality of first terminals each corresponding to a first target; and
a plurality of second terminals each corresponding a second target,
wherein the plurality of first terminals and the plurality of second terminals are configured so that in response to occurrence of a use relation between the first target and the second target, at least one of the first terminal corresponding to the first target, and the second terminal corresponding to the second target transmits a linking demand to the management server,
the management server is configured to execute:
accepting setting of a correspondence relation between the first target and the second target, in response to receipt of the linking demand; and
if, while setting of a first correspondence relation between a first first target and a first second target is established, setting of a second correspondence relation between the first first target and a second second target different from the first second target is accepted, (I) releasing the first correspondence relation, and establishing setting of the second correspondence relation, or (II) not permitting setting the second correspondence relation, and maintaining the setting of the first correspondence relation, according to a predetermined rule.

3. The system according to claim 2,
wherein the management server is further configured to receive a selection result by the first first target, and
the management server is configured:
(I) to release the first correspondence relation, and to establish the setting of the second correspondence relation, if the second correspondence relation is selected in the received selection result, and
(II) not to permit setting the second correspondence relation, and to maintain the setting of the first correspondence relation, if the first correspondence relation is selected in the selection result.

4. The system according to claim 2,
wherein the management server is configured:
(I) to release the first correspondence relation, and to establish the setting of the second correspondence relation, if a predetermined relation is not established between the first second target and the second second target, and
(II) not to permit setting the second correspondence relation, and to maintain the setting of the first correspondence relation, if the predetermined relation is established between the first second target and the second second target.

5. The system according to claim 2,
wherein the management server is configured:
(I) to release the first correspondence relation, and to establish the setting of the second correspondence relation, if a type of the second second target is different from a type of the first second target, and
(II) not to permit setting the second correspondence relation, and to maintain the setting of the first correspondence relation, if the type of the second second target is identical to the type of the first second target.

6. The system according to claim 2,
wherein the first target is a user,
the second target is an object to be used by the user, and
it is configured such that in a case where a type of the first second target is a rental object, the management server:
(I) releases the first correspondence relation, and establishes the setting of the second correspondence relation, if a type of the second second target is not the rental object, and
(II) does not permit setting the second correspondence relation, and maintains the setting of the first correspondence relation, if the type of the second second target is the rental object.

7. The system according to claim 6,
wherein the object to be used is a vehicle, and
the rental object is a rental car.

8. The system according to claim 2,
wherein each of the first terminals includes a positioning module,
each of the second terminals includes a positioning module,
it is configured such that upon acceptance of the setting of the second correspondence relation, the management server further executes:
obtaining, from a first first terminal corresponding to the first first target, a current position of the first first terminal measured by the positioning module of the first first terminal; and
obtaining, from a second second terminal corresponding to the second second target, a current position of the second second terminal measured by the positioning module of the second second terminal, and
the management server is configured:
(I) to release the first correspondence relation, and to establish the setting of the second correspondence relation, if a relation between the obtained current positions of the first first terminal and the second second terminal satisfies a condition of the use relation; and
(II) not to permit setting the second correspondence relation, and to maintain the setting of the first correspondence relation, if a relation between the obtained current positions of the first first terminal and the second second terminal does not satisfy a condition of the use relation.

9. The system according to claim 2,
wherein the management server is further configured to inhibit release of the correspondence relation by locking the setting of the correspondence relation until a predetermined condition is satisfied, if the correspondence relation is set with a predetermined type of the second target, and
it is configured such that in a case where the first second target is of the predetermined type, the management server:
(II) does not permit setting the second correspondence relation, and maintains the setting of the first correspondence relation, if the setting of the second correspondence relation is accepted while the first correspondence relation is locked; and
(I) releases the first correspondence relation, and establishes setting of the second correspondence relation, if the setting of the second correspondence relation is accepted after the locking of the first correspondence relation is released.

10. The system according to claim 9,
wherein the first target is a user,
the second target of the predetermined type is a mobile body of a public transport system, and
the predetermined condition is completion of payment of a charge for use of the mobile body of the public transport system.

11. The system according to claim 2,
wherein it is configured so that in response to establishment of the correspondence relation between the first target and the second target, the management server further executes activation of exercising an authority associated with the corresponding first target through the second target with which the correspondence relation is set.

12. A management server, comprising a processor configured to execute:
receiving a linking demand, from at least one of a first terminal as a first target and a second terminal as a second target, in response to occurrence of a use relation between the first target and the second target;
accepting setting of a correspondence relation between the first target and the second target, in response to receipt of the linking demand; and
if, while setting of a first correspondence relation between a first first target and a first second target is established, setting of a second correspondence relation between the first first target and a second second target different from the first second target is accepted, (I) releasing the first correspondence relation, and establishing setting of the second correspondence relation, or (II) not permitting setting the second correspondence relation, and maintaining the setting of the first correspondence relation, according to a predetermined rule.

13. The management server according to claim 12,
wherein the processor is configured:
(I) to release the first correspondence relation, and to establish the setting of the second correspondence relation, if a predetermined relation is not established between the first second target and the second second target; and
(II) not to permit setting the second correspondence relation, and to maintain the setting of the first correspondence relation, if the predetermined relation is established between the first second target and the second second target.

14. The management server according to claim 12,
wherein the processor is configured:
(I) to release the first correspondence relation, and to establish the setting of the second correspondence relation, if a type of the second second target is different from a type of the first second target, and
(II) not to permit setting the second correspondence relation, and to maintain the setting of the first correspondence relation, if the type of the second second target is identical to the type of the first second target.

15. The management server according to claim 12,
wherein the first target is a user,
the second target is an object to be used by the user, and
a type of the first second target is a rental object, and
the processor is configured:
(I) to release the first correspondence relation, and to establish the setting of the second correspondence relation, if a type of the second second target is not the rental object; and
(II) not to permit setting the second correspondence relation, and to maintain the setting of the first correspondence relation, if the type of the second second target is the rental object.

16. The management server according to claim 12,
wherein it is configured such that upon acceptance of the setting of the second correspondence relation, the processor further executes:
obtaining, from a first first terminal corresponding to the first first target, a current position of the first first terminal measured by a positioning module of the first first terminal; and
obtaining, from a second second terminal corresponding to the second second target, a current position of the second second terminal measured by a positioning module of the second second terminal, and
the processor is configured:
(I) to release the first correspondence relation, and to establish the setting of the second correspondence relation, if a relation between the obtained current positions of the first first terminal and the second second terminal satisfies a condition of the use relation; and
(II) not to permit setting the second correspondence relation, and to maintain the setting of the first correspondence relation, if the relation between the obtained current positions of the first first terminal and the second second terminal does not satisfy the condition of the use relation.

17. The management server according to claim 12,
wherein the processor is further configured to inhibit release of the correspondence relation by locking the setting of the correspondence relation until a predetermined condition is satisfied, if the correspondence relation is set with a predetermined type of the second target, and
it is configured such that if the first second target is of the predetermined type, the processor:
(II) does not permit setting the second correspondence relation, and maintains the setting of the first correspondence relation, if the setting of the second correspondence relation is accepted while the first correspondence relation is locked; and
(I) releases the first correspondence relation, and establishes setting of the second correspondence relation, if the setting of the second correspondence relation is accepted after the locking of the first correspondence relation is released.
